(19) United States
(12) Patent Application Publication
(10) Pub. No.: US 2025/0175952 A1
(43) Pub. Date: May 29, 2025

(54) TRANSMISSION CONFIGURATION INDICATOR FOR WIRELESS COMMUNICATION

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/840,376

(22) PCT Filed: Apr. 22, 2022
(86) PCT No.: PCT/CN2022/088454

§ 371 Date: Aug. 21, 2024

(51) Int. Cl. H04W 72/0446; H04B 7/06; H04W 72/23

(52) U.S. Cl. CPC H04W 72/0446; H04B 7/0626; H04B 7/06968; H04W 72/23

(57) ABSTRACT

Aspects relate to receiving a transmission using a beam associated with a transmission configuration indicator (TCI) state. In some examples, a user equipment may use a beam associated with a TCI state indicated by control information that scheduled the transmission. In some examples, the user equipment may use a beam associated with a TCI configured for another transmission. In some examples, the user equipment may use a beam associated with a first control resource set of a set of monitored control resource sets, where the first control resource set has the lowest control resource set identifier of the set.

### TECHNICAL FIELD

The technology discussed below relates generally to wireless communication and, more particularly, to receiving information based on a transmission configuration indicator (TCI).

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) to be used by different UEs operating within the cell. In some examples, the base station may send downlink control information to a UE that identifies the resources to be used for a downlink transmission to a UE or an uplink transmission from a UE, as well as other information that the UE can use to receive the downlink transmission or transmit the uplink transmission.

Some wireless communication systems use a channel state information reference signal (CSI-RS) for channel estimation. For example, a base station may send a CSI-RS to a UE and, in response, the UE sends a measurement report based on the CSI-RS to the base station. The base station may then use the measurement report to estimate one or more characteristics of a channel between the base station and the UE.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a user equipment may include a transceiver, a memory, and a processor coupled to the transceiver and the memory. The processor and the memory may be configured to receive, via the transceiver, an indication of a first transmission configuration indicator state associated with a plurality of transmissions. The processor and the memory may also be configured to receive, via the transceiver during a first slot, control information that schedules a first transmission during a second slot. In some examples, the second slot follows the first slot by a duration of time that is less than a threshold duration. The processor and the memory may be further configured to receive, via the transceiver, the first transmission using a beam indicated by the first transmission configuration indicator state. In some examples, the reception of the first transmission using the beam indicated by the first transmission configuration indicator state is based on the second slot following the first slot by the duration of time that is less than the threshold duration.

In some examples, a method for wireless communication at a user equipment is disclosed. The method may include receiving an indication of a first transmission configuration indicator state associated with a plurality of transmissions. The method may also include receiving, during a first slot, control information that schedules a first transmission during a second slot. In some examples, the second slot follows the first slot by a duration of time that is less than a threshold duration. The method may further include receiving the first transmission using a beam indicated by the first transmission configuration indicator state. In some examples, the receiving the first transmission using the beam indicated by the first transmission configuration indicator state is based on the second slot following the first slot by the duration of time that is less than the threshold duration.

In some examples, a user equipment may include means for receiving an indication of a first transmission configuration indicator state associated with a plurality of transmissions. The user equipment may also include means for receiving, during a first slot, control information that schedules a first transmission during a second slot. In some examples, the second slot follows the first slot by a duration of time that is less than a threshold duration. The user equipment may further include means for receiving the first transmission using a beam indicated by the first transmission configuration indicator state. In some examples, the receiving the first transmission using the beam indicated by the first transmission configuration indicator state is based on the second slot following the first slot by the duration of time that is less than the threshold duration.

In some examples, a non-transitory computer-readable medium has stored therein instructions executable by one or more processors of a user equipment to receive an indication of a first transmission configuration indicator state associated with a plurality of transmissions. The computer-readable medium may also have stored therein instructions executable by one or more processors of the user equipment to receive, during a first slot, control information that schedules a first transmission during a second slot. In some examples, the second slot follows the first slot by a duration of time that is less than a threshold duration. The computer-readable medium may further have stored therein instructions executable by one or more processors of the user equipment to receive the first transmission using a beam indicated by the first transmission configuration indicator state. In some examples, the reception of the first transmission using the beam indicated by the first transmission configuration indicator state is based on the second slot following the first slot by the duration of time that is less than the threshold duration.

In some examples, a user equipment may include a transceiver, a memory, and a processor coupled to the transceiver and the memory. The processor and the memory may be configured to receive, via the transceiver during a first slot, control information for a first transmission that is scheduled during a second slot. In some examples, the second slot follows the first slot by less than a threshold duration. The processor and the memory may also be configured to receive, via the transceiver, the first transmission using a beam associated with a first control resource set of at least one control resource set being monitored by the user equipment. In some examples, the first control resource set has a lowest control resource set identifier of the at least one control resource set. In some examples, the reception of the first transmission using the beam associated with the first control resource set is based on an absence of, for the user equipment, a configured transmission configuration indicator state associated with a plurality of transmissions.

In some examples, a method for wireless communication at a user equipment is disclosed. The method may include receiving, during a first slot, control information for a first transmission that is scheduled during a second slot. In some examples, the second slot follows the first slot by less than a threshold duration. The method may also include receiving the first transmission using a beam associated with a first control resource set of at least one control resource set being monitored by the user equipment. In some examples, the first control resource set has a lowest control resource set identifier of the at least one control resource set. In some examples, the reception of the first transmission using the beam associated with the first control resource set is based on an absence of, for the user equipment, a configured transmission configuration indicator state associated with a plurality of transmissions.

In some examples, a user equipment may include means for receiving, during a first slot, control information for a first transmission that is scheduled during a second slot. In some examples, the second slot follows the first slot by less than a threshold duration. The user equipment may also include means for receiving the first transmission using a beam associated with a first control resource set of at least one control resource set being monitored by the user equipment. In some examples, the first control resource set has a lowest control resource set identifier of the at least one control resource set. In some examples, the reception of the first transmission using the beam associated with the first control resource set is based on an absence of, for the user equipment, a configured transmission configuration indicator state associated with a plurality of transmissions.

In some examples, a non-transitory computer-readable medium has stored therein instructions executable by one or more processors of a user equipment to receive, during a first slot, control information for a first transmission that is scheduled during a second slot. In some examples, the second slot follows the first slot by less than a threshold duration. The computer-readable medium may also have stored therein instructions executable by one or more processors of the user equipment to receive the first transmission using a beam associated with a first control resource set of at least one control resource set being monitored by the user equipment. In some examples, the first control resource set has a lowest control resource set identifier of the at least one control resource set. In some examples, the reception of the first transmission using the beam associated with the first control resource set is based on an absence of, for the user equipment, a configured transmission configuration indicator state associated with a plurality of transmissions.

In some examples, a user equipment may include a transceiver, a memory, and a processor coupled to the transceiver and the memory. The processor and the memory may be configured to receive, via the transceiver during a first slot, control information for a first transmission that is scheduled during a second slot. In some examples, the second slot follows the first slot by less than a threshold duration. The processor and the memory may also be configured to receive, via the transceiver, the first transmission using a beam associated with a second transmission that is scheduled, at least in part, during the second slot. In some examples, the second transmission is configured to use a first transmission configuration indicator state that is associated with a plurality of transmissions.

In some examples, a method for wireless communication at a user equipment is disclosed. The method may include receiving, during a first slot, control information for a first transmission that is scheduled during a second slot. In some examples, the second slot follows the first slot by less than a threshold duration. The method may also include receiving the first transmission using a beam associated with a second transmission that is scheduled, at least in part, during the second slot. In some examples, the second transmission is configured to use a first transmission configuration indicator state that is associated with a plurality of transmissions.

In some examples, a user equipment may include means for receiving, during a first slot, control information for a first transmission that is scheduled during a second slot. In some examples, the second slot follows the first slot by less than a threshold duration. The user equipment may also include means for receiving the first transmission using a beam associated with a second transmission that is scheduled, at least in part, during the second slot. In some examples, the second transmission is configured to use a first transmission configuration indicator state that is associated with a plurality of transmissions.

In some examples, a non-transitory computer-readable medium has stored therein instructions executable by one or more processors of a user equipment to receive, during a first slot, control information for a first transmission that is scheduled during a second slot. In some examples, the second slot follows the first slot by less than a threshold duration. The computer-readable medium may also have stored therein instructions executable by one or more processors of the user equipment to receive the first transmission using a beam associated with a second transmission that is scheduled, at least in part, during the second slot. In some examples, the second transmission is configured to use a first transmission configuration indicator state that is associated with a plurality of transmissions.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an example of distributed entities in a radio access network according to some aspects.

FIG. 4 is a schematic illustration of wireless resources in an air interface utilizing orthogonal frequency divisional multiplexing (OFDM) according to some aspects.

FIG. 5 is a schematic illustration of an example of a downlink control region of a slot according to some aspects.

FIG. 6 is a schematic illustration of an example of a control channel element structure according to some aspects.

FIG. 7 is a schematic illustration of an example of downlink time-frequency resources according to some aspects.

FIG. 8 is a signaling diagram illustrating an example of signaling associated with scheduling a physical downlink shared channel (PDSCH) according to some aspects.

FIG. 9 is a signaling diagram illustrating an example of signaling associated with scheduling a channel state information-reference signal (CSI-RS) according to some aspects.

FIG. 10 is a diagram illustrating an example of a common transmission configuration indicator (TCI) state pool according to some aspects.

FIG. 11 is a signaling diagram illustrating an example of signaling associated with identifying a beam to use for receiving a transmission according to some aspects.

FIG. 12 is a conceptual illustration of an example of downlink control information scheduling a transmission according to some aspects.

FIG. 13 is a flow chart illustrating an example method for identifying a beam for receiving a physical downlink shared channel (PDSCH) transmission according to some aspects.

FIG. 14 is a conceptual illustration of an example of a control resource set associated with beam information that may be used to receive a transmission according to some aspects.

FIG. 15 is a conceptual illustration of an example of a transmission associated with beam information that may be used to receive an aperiodic CSI-RS transmission according to some aspects.

FIG. 16 is a flow chart illustrating an example method for identifying a beam for receiving an aperiodic CSI-RS transmission according to some aspects.

FIG. 17 is a block diagram conceptually illustrating another example method for identifying a beam for receiving an aperiodic CSI-RS transmission according to some aspects.

FIG. 18 is a block diagram conceptually illustrating an example of a hardware implementation for a user equipment employing a processing system according to some aspects.

FIG. 19 is a flow chart illustrating an example wireless communication method for receiving a transmission according to some aspects.

FIG. 20 is a flow chart illustrating another example wireless communication method for receiving a transmission according to some aspects.

FIG. 21 is a flow chart illustrating another example wireless communication method for receiving a transmission according to some aspects.

FIG. 22 is a block diagram conceptually illustrating an example of a hardware implementation for a network entity employing a processing system according to some aspects.

FIG. 23 is a flow chart illustrating an example wireless communication method for transmitting a transmission according to some aspects.

FIG. 24 is a flow chart illustrating another example wireless communication method for transmitting a transmission according to some aspects.

FIG. 25 is a flow chart illustrating another example wireless communication method for transmitting a transmission according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to use of a communication configuration for receiving a transmission. In some examples, a communication configuration may specify quasi colocation information (e.g., beam information) that a user equipment (UE) may use to receive the transmission. In some examples, the communication configuration may be a transmission configuration indicator (TCI) state. In some examples, the transmission may be a physical downlink shared channel (PDSCH) transmission, an aperiodic channel state information-reference signal (aperiodic CSI-RS) transmission, or a physical sidelink shared channel (PSSCH).

In some examples, a UE may use a specified communication configuration to receive the transmission. For example, the communication configuration may be indicated in control information (e.g., downlink control information) that scheduled a transmission.

In some examples, the user equipment may use a default communication configuration to receive the transmission. For example, a user equipment may use a default communication configuration in a scenario where the user equipment has not yet received a TCI state for the transmission. In some cases, TCI state information might not be available due to a short time gap between the time of the transmission of the control information that scheduled the transmission (and that carries an indication of the associated TCI state) and the time of the scheduled transmission.

The disclosure relates in some aspects to identifying a default communication configuration to be used for receiving a first transmission (e.g., in the event a specified communication configuration is not available). In some examples, a user equipment determines whether there is second transmission that is scheduled, at least in part, in the same slot as the first transmission and that has a configured TCI. If so, the user equipment may use the TCI state configured for the second transmission to receive the first transmission. In the event such a second transmission is not scheduled, to receive the first transmission, the user equipment may use quasi co-location information defined for a first control resource set of a set of control resource sets monitored by the user equipment, where the first control resource set has the lowest control resource set identifier of the set, and where the control resource set is associated with the latest monitored slot that occurs prior to the slot scheduled for the first transmission.

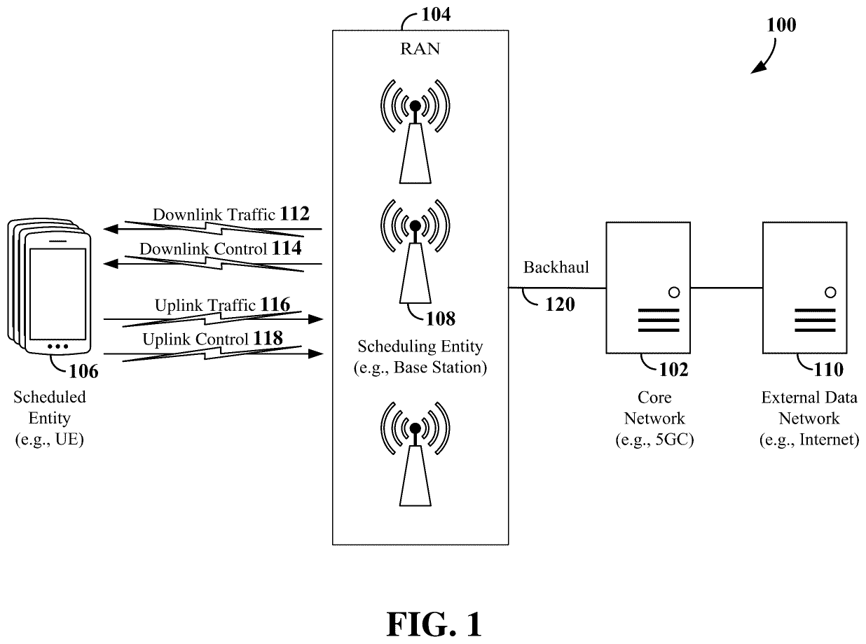

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (CUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

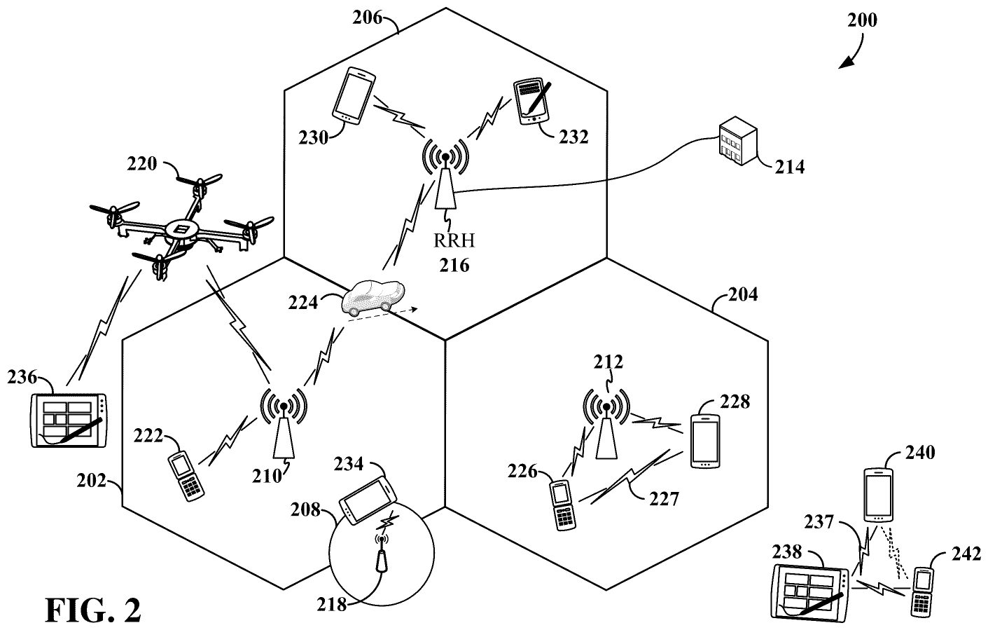

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

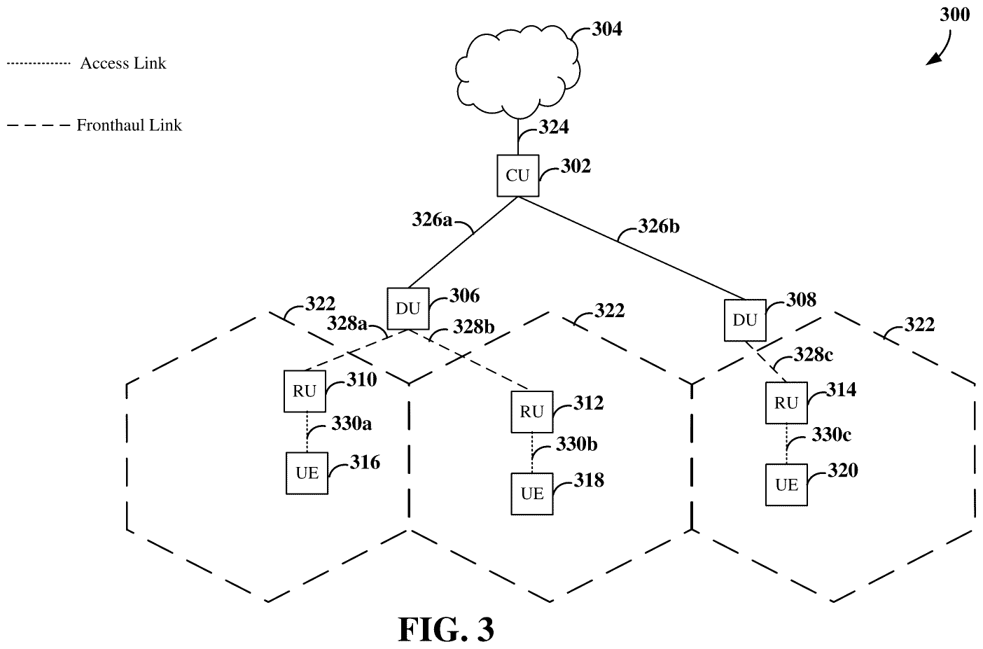

FIG. 3 is a diagram illustrating an example of a RAN 300 (e.g., a disaggregated RAN) including distributed wireless communication nodes (entities) according to some aspects. The RAN 300 may be similar to the radio access network 200 shown in FIG. 2, in that the RAN 300 may be divided into a number of cells (e.g., cells 322) each of which may be served by respective network nodes (e.g., control units, distributed units, and radio units). The network nodes may constitute access points, base stations (BSs), eNBs, gNBs, or other nodes that utilize wireless spectrum (e.g., the radio frequency (RF) spectrum) and/or other communication links to support access for one or more UEs located within the cells. In some examples, some or all of the nodes of FIG. 3 may be implemented as an integrated access backhaul (IAB). In some examples, some or all of the nodes of FIG. 3 may be implemented according an open-radio access network (O-RAN) specification.

In some examples, the RAN 300 may be implemented, at least in part, according to a disaggregated base station architecture (e.g., where different base station functions may be implemented in different entities). In some examples, such an architecture may include RF functions, low PHY layer functions, high PHY layer functions, low MAC layer functions, high MAC layer functions, low RLC layer functions, high RLC layer functions, PDCP layer functions, and RRC layer functions that may be implemented in different network nodes (e.g., control units, distributed units, and radio units) in different examples.

In the example of FIG. 3, a control unit (CU) 302 communicates with a core network 304 via a backhaul link 324, and communicates with a first distributed unit (DU) 306 and a second distributed unit 308 via respective midhaul links 326a and 326b. The first distributed unit 306 communicates with a first radio unit (RU) 310 and a second radio unit 312 via respective fronthaul links 328a and 328b. The second distributed unit 308 communicates with a third radio unit 314 via a fronthaul link 328c. The first radio unit 310 communicates with at least one UE 316 via at least one RF access link 330a. The second radio unit 312 communicates with at least one UE 318 via at least one RF access link 330b. The third radio unit 314 communicates with at least one UE 320 via at least one RF access link 330c.

In some examples, a control unit (e.g., the CU 302) is a logical node that hosts a packet data convergence protocol (PDCP) layer, a radio resource control (RRC) layer, a service data adaptation protocol (SDAP) layer and other control functions. A control unit may also terminate interfaces (e.g., an E1 interface, an E2 interface, etc., not shown in FIG. 3) to network nodes (e.g., nodes of a core network). In addition, an F1 interface (not shown in FIG. 3) may provide a mechanism to interconnect a control unit (e.g., the PDCP layer and higher layers) and a distributed unit (e.g., the radio link control (RLC) layer and lower layers). In some aspects, an F1 interface may provide control plane and user plane functions (e.g., interface management, system information management, UE context management, RRC message transfer, etc.). For example, the F1 interface may support F1-C on the control plane and F1-U on the user plane. FIAP is an application protocol for F1 that defines signaling procedures for F1 in some examples.

In some examples, a distributed unit (e.g., the DU 306 or the DU 308) is a logical node that hosts an RLC layer, a medium access control (MAC) layer, and a high physical (PHY) layer based on a lower layer functional split (LLS). In some aspects, a distributed unit may control the operation of at least one radio unit. A distributed unit may also terminate interfaces (e.g., F1, E2, etc.) to the control unit and/or other network nodes. In some examples, a high PHY layer includes portions of the PHY processing such as forward error correction 1 (FEC 1) encoding and decoding, scrambling, modulation, and demodulation.

In some examples, a radio unit (e.g., the RU 310, the RU 312, or the RU 314) is a logical node that hosts low PHY layer and radio frequency (RF) processing based on a lower layer functional split. In some examples, a radio unit may be similar to a 3GPP transmit receive point (TRP) or remote radio head (RRH), while also including the low PHY layer. In some examples, a low PHY layer includes portions of the PHY processing such as fast Fourier transform (FFT), inverse FFT (IFFT), digital beamforming, and physical random access channel (PRACH) extraction and filtering. The radio unit may also include a radio chain for communicating with one or more UEs.

The functionality splits between the entities of the RAN 300 may be different in different examples. In some examples, Layer 1 functions, Layer 2 functions, and Layer 3 functions may be allocated among the RU, DU, and CU entities. Examples of Layer 1 functions include RF functions and low PHY layer functions. Examples of Layer 2 functions include high PHY layer functions, low MAC layer functions, high MAC layer functions, low RLC layer functions, and high RLC layer functions. Examples of Layer 3 functions include PDCP layer functions and RRC layer functions. Other functionality splits may be used in other examples.

As discussed above, the two Layer 3 functions may be implemented in a CU in some examples. The other seven functions may thus be split between the RU and the DU in this case. In some examples, the Layer 1 functions are implemented in the RU and the Layer 2 functions are implemented in the DU. In some examples, all PHY functionality is implemented in the RU (i.e., the high PHY layer functions are implemented in the RU and not the DU). Other functionality splits may be used in other examples.

Different splits may be used between low layer functionality and high layer functionality in different examples. For example, the split between the low PHY layer functionality and the high PHY layer functionality may be defined between RE mapping and precoding in some cases. Thus, the RE mapping may be designated as a low PHY layer function performed by an RU and the precoding may be designated as a high PHY layer function performed by a DU in such a case. Other functionality splits may be used in other examples.

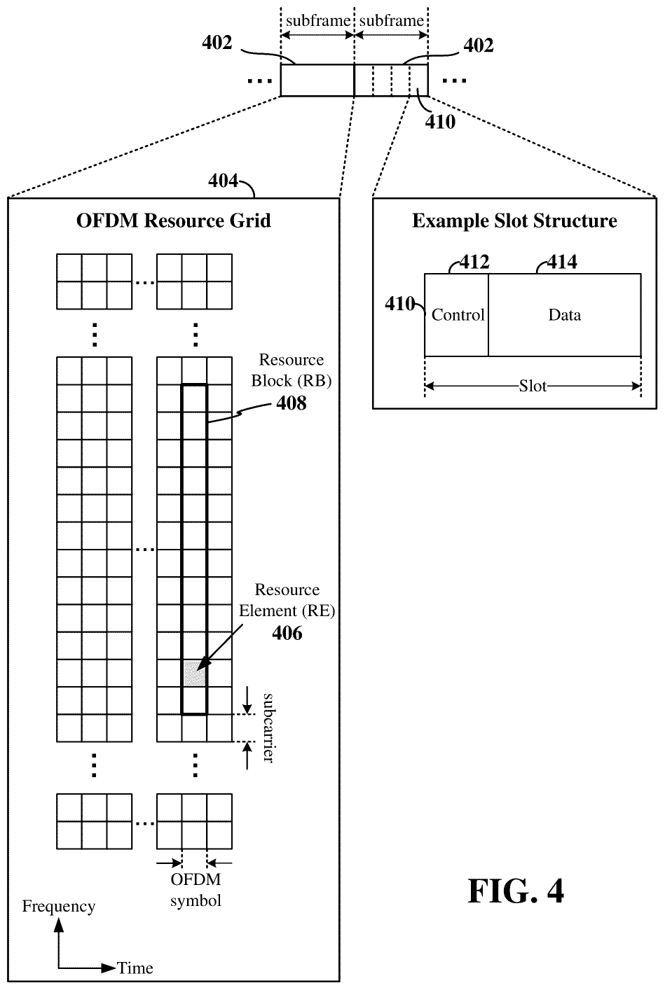

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

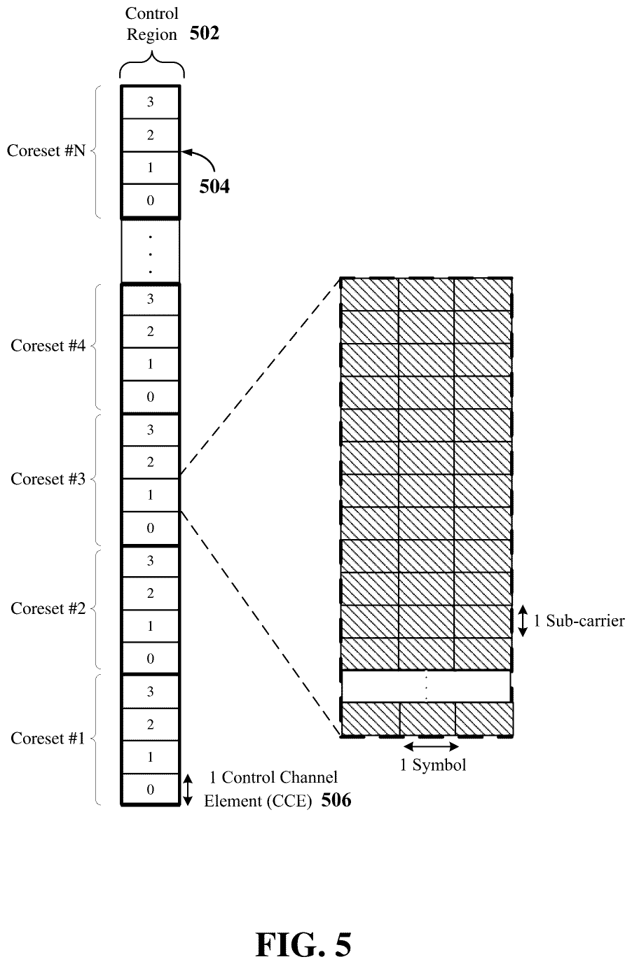

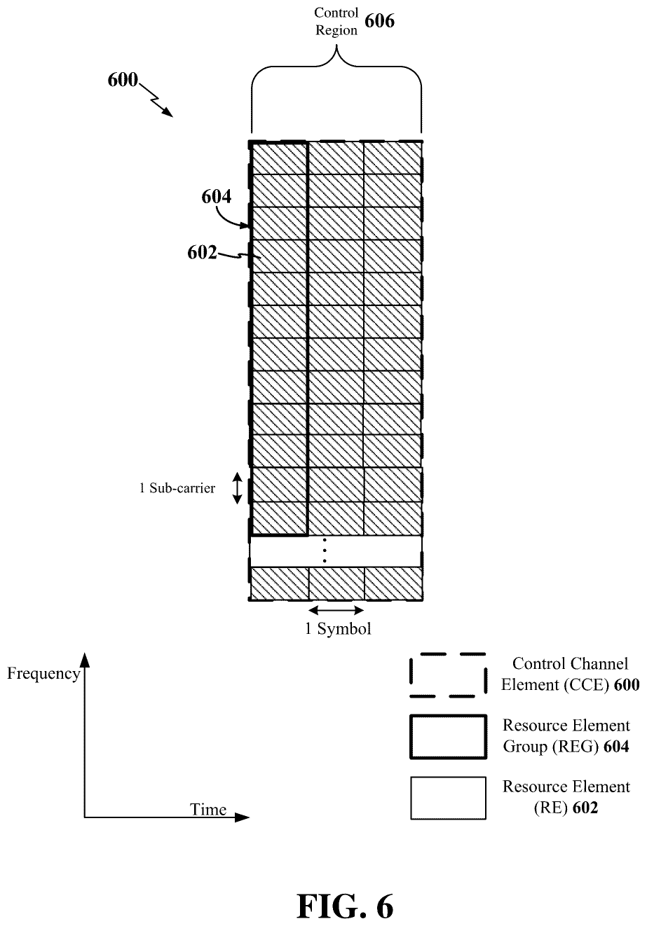

As mentioned above, a base station may use a downlink control region of a slot to send PDCCH information to a UE. In some examples, the PDCCH information may be a scheduling DCI that schedules a downlink transmission to a UE, a scheduling DCI that schedules an uplink transmission by a UE, or a scheduling DCI that schedules some other transmission. In some examples, the PDCCH information may be a non-scheduling DCI (e.g., a DCI that carries information, but does not schedule a transmission). FIGS. 5 and 6 describe example resource configurations that may be used to carry such PDCCH information.

FIG. 5 is a schematic illustration of an example of a downlink (DL) control region 502 of a slot according to some aspects. The DL control region 502 may correspond, for example, to the control region 412 of the slot 410 illustrated in FIG. 4. As discussed above, the DL control region 502 may carry a PDCCH that includes one or more DCIs.

The DL control region 502 includes a plurality of CORESETs 504 indexed as CORESET #1-CORESET #N. Each CORESET 504 includes a number of sub-carriers in the frequency domain and one or more symbols in the time domain. In the example of FIG. 5, each CORESET 504 includes at least one control channel element (CCE) 506 having dimensions in both frequency and time, sized to span across at least three OFDM symbols. A CORESET 504 having a size that spans across two or more OFDM symbols may be beneficial for use over a relatively small system bandwidth (e.g., 5 MHZ). However, a one-symbol CORESET may be used in some scenarios.

In some examples, a base station may configure a CORESET 504 for carrying group common control information or UE-specific control information, whereby the CORESET 504 may be used for transmission of a PDCCH including the group common control information or the UE-specific control information to one or more UEs. Each UE may be configured to monitor one or more CORESETs 504 for the UE-specific or group common control information (e.g., on a PDCCH).

In some examples, the PDCCH may be constructed from a variable number of CCEs, depending on the PDCCH format (e.g., aggregation level). Each PDCCH format (e.g., aggregation level) supports a different DCI length. In some examples, PDCCH aggregation levels of 1, 2, 4, 8, and 16 may be supported, corresponding to 1, 2, 4, 8, or 16 contiguous CCEs, respectively.

FIG. 6 is a schematic illustration of an example of a CCE structure 600 in a DL control region 606 of a slot according to some aspects. The DL control region 606 may correspond, for example, to the control region 412 of the slot 410 illustrated in FIG. 4. The CCE structure 600 includes a number of REs 602 that may be grouped into at least one RE group (REG) 604. Each REG 604 generally may contain, for example, twelve consecutive REs 602 (or nine REs 602 and three DMRS REs) within the same OFDM symbol and the same RB. In the example of FIG. 6, the CCE structure 600 includes at least six REGs 604 (not shown in their entirety) distributed across three OFDM symbols. However, as those skilled in the art will readily appreciate, the CCE structure 600 for any particular application may vary from the example described herein, depending on any number of factors. For example, the CCE structure 600 may contain any suitable number of REGs.

In some examples, a UE may be unaware of the particular aggregation level of the PDCCH or whether multiple PDCCHs may exist for the UE in the slot. Consequently, the UE may perform blind decoding of various PDCCH candidates within the first N control OFDM symbols of the slot (as indicated by the slot format of the slot) and/or other OFDM symbols of the slot. In some examples, this decoding is based on a radio network temporary identifier (RNTI) (e.g., a UE-specific RNTI or a group RNTI) that the base station is expected to use when encoding the PDCCH. Each PDCCH candidate includes a collection of one or more consecutive CCEs based on an assumed DCI length (e.g., PDCCH aggregation level). The term PDCCH candidate is used here to emphasize that the UE might not be configured with information indicating exactly what type of PDCCH is carried within a slot or where a particular PDCCH is carried within a slot. Thus, with blind decoding, the UE attempts to decode signals received on different sets of resource (e.g., corresponding to different PDCCH candidates) to determine whether those resources are actually carrying a PDCCH.

To limit the number of blind decodes performed by a UE, a base station may configure certain search spaces such as UE-specific search spaces (USSs) and common search spaces (CSSs). Here, the base station may send a PDCCH to a UE or a set of UEs only on the resources specified for the configured search space(s). Thus, the UE or UEs may limit their blind decoding to the configured search space(s). In some examples, the base station may configure one or more search space sets, each of which includes at least one search space. In some examples, different search space sets may be assigned different search space set identifiers (IDs). In some examples, a search space set ID may be referred to as a search space set index.

A UE-specific search space set consist of CCEs used for sending control information to a particular UE. The starting point (offset or index) of a UE-specific search space may be different for each UE. In addition, each UE may have multiple UE-specific search spaces (e.g., a respective one for each aggregation level).

A common search space sets consists of CCEs used for sending control information that is common to a group of UEs or to all UEs (e.g., under a given cell). Thus, the common search space sets are monitored by multiple UEs in a cell. The starting point (offset or index) of a search space set for group common control information may be the same for all UEs in the group and there may be multiple search space sets defined for group common control information (e.g., a respective one for each configured aggregation level for the group of UEs).

A UE may perform blind decoding over all aggregation levels and corresponding USSs or CSSs to determine whether at least one valid DCI is carried by the UE-specific search space (USS) or the common search space (CSS) for the UE. By using search space sets (e.g., USSs and CSSs) configured for a UE for this blind decoding, the number of blind decodes that the UE performs for each PDCCH format combination may be reduced (e.g., as compared to a scenario that does not use search space sets).

A UE may monitor a search space for downlink assignments and uplink grants relating to a particular component carrier for the UE. For example, the UE may monitor the search space for a PDCCH that includes a DCI that schedules a PDSCH in the same slot or in a different slot for that component carrier. In this case, the DCI includes a frequency domain resource assignment and a time domain resource assignment for a PDSCH and other information (e.g., MCS, etc.) that enables the UE to decode the PDSCH.

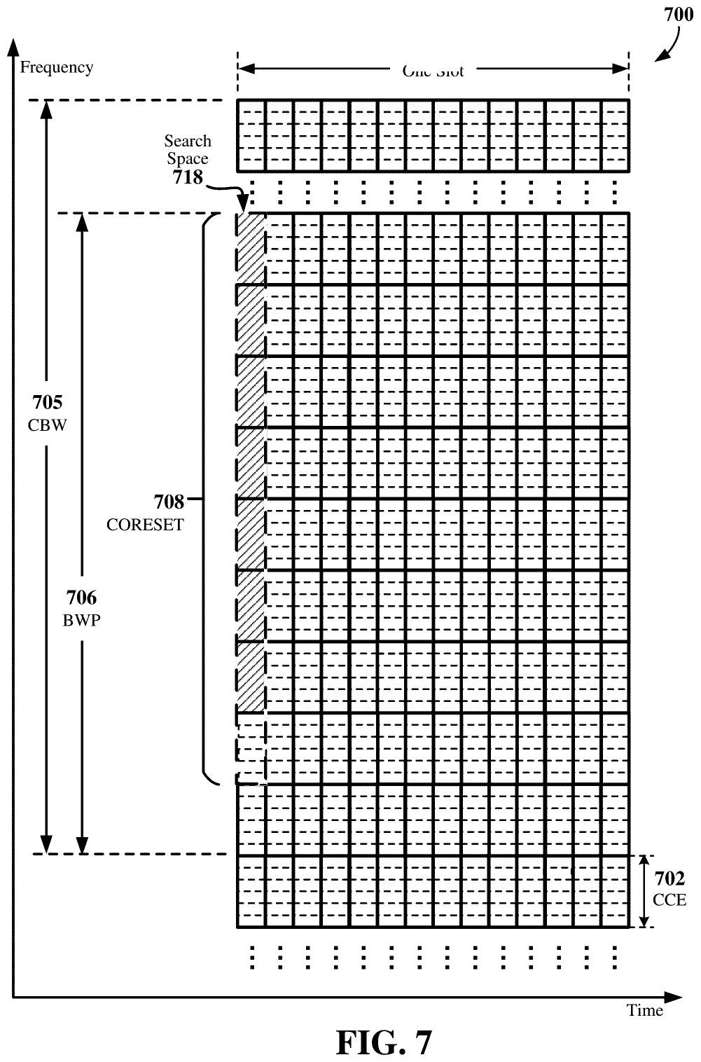

FIG. 7 is a schematic illustration of an example of downlink time-frequency resources 700, where a search space is defined within a CORESET. In FIG. 7, time is in the horizontal direction with units of OFDM symbols and frequency is in the vertical direction with units of CCEs. For example, the vertical dimension of each major solid line rectangle represents one CCE 702. Each CCE 702 includes 6 resource element groups (REGs). Each REG may correspond to one physical resource block (PRB), including 12 resource elements (REs) in the frequency domain and one OFDM symbol in the time domain. The 6 REGs of each CCE 702 are respectively represented by a minor dashed line rectangle. One slot 704 in the time domain is represented. Other resource configurations may be used in other examples.

FIG. 7 depicts one bandwidth part (BWP) 706 within a carrier bandwidth (CBW) 705. According to some aspects, the BWP 706 is a contiguous set of physical resource blocks (PRBs) on a given carrier. In the example of FIG. 7, the contiguous set of PRBs are represented by a contiguous set of CCEs 702. In addition, the BWP 706 corresponds to a set of 64 PRBs, which represent 648 subcarriers (i.e., 12 REs/REG x 6 REGs/CCE x 9 CCEs). A base station may configure different sets of these CCEs as common CCEs or UE-specific CCEs.

In the example of FIG. 7, a CORESET 708 includes 48 REGs in one set of eight CCEs (where each CCE may be similar to the CCE 702). The eight CCEs may be grouped as a first DCI.

A CORESET may include a one or more search spaces. A search space may include all or a portion of a CORESET. A CORESET may be associated with a common search space, a UE-specific search space, or a combination of both. In the example of FIG. 7, one search space (SS) 718 is indicated for the CORESET 708 (represented by the slanted lines).

A search space may include a number of PDCCH candidates. As mentioned above, a UE may attempt to blind decode a PDCCH candidate in each search space; even if a base station did not schedule a PDCCH in any given search space.

The following relationships between CORESETs, BWPs, and search spaces are made with reference to some examples of NR; however, the following is an example and non-limiting and other relationships between CORESETs, BWPs, and search spaces (or their equivalents, for example in other radio technologies) are within the scope of the disclosure. In some examples, for a given UE, a base station may configure up to three CORESETs in a BWP of a serving cell (e.g., a component carrier (CC)), including both common and UE-specific CORESETs. In addition, the base station may configure up to four BWPs per serving cell, with one of the BWPs active at a given time. Accordingly, a maximum number of CORESETs for a UE per serving cell may be twelve (e.g., 3 CORESETs per BWP x 4 BWPs per serving cell) in these examples. The resource elements of a CORESET may be mapped to one or more CCEs. One or more CCEs from one CORESET may be aggregated to form the resources used by one PDCCH. In some examples, the maximum number of search spaces per BWP may be ten (10). In some examples, multiple search spaces may use the time-frequency resources of one CORESET.

A base station may send a PDCCH to a UE via the downlink time-frequency resources 700 (e.g., within a configured search space). In some examples, the base station may compute a cyclic redundancy check (CRC) of a payload of a DCI carried by a PDCCH. The CRC may be scrambled using an identifier of a UE. An example of such an identifier may be a radio network temporary identifier (RNTI), such as a random access-radio network temporary identifier (RA-RNTI).

During blind decoding of a search space, the UE may attempt to descramble CRC of a PDCCH candidate using the RNTI. For example, the UE may compute a CRC on the payload of the corresponding DCI using the same procedure as used by the base station, and then compare the CRCs. If the CRCs are equal, the DCI was destined for the UE. If the payload was corrupted or the CRC was scrambled using another UE's RNTI, then the CRCs would not match, and the UE may disregard the DCI.

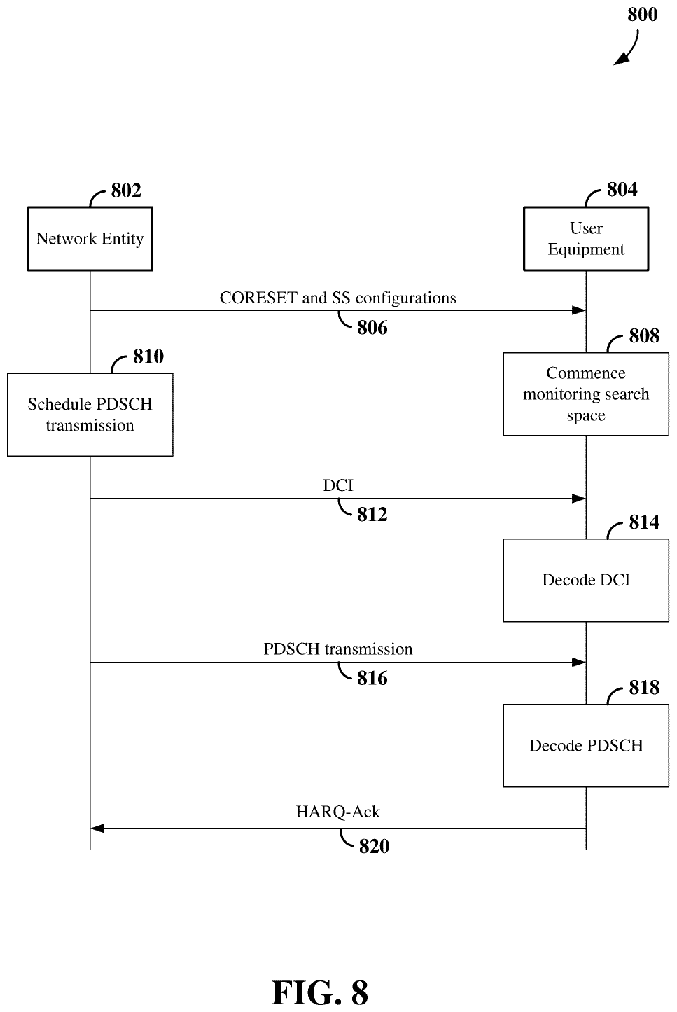

FIG. 8 is a signaling diagram 800 illustrating an example of PDSCH scheduling in a wireless communication system including a network entity 802 and a user equipment 804. In some examples, the network entity 802 may correspond to any of the base stations, CUs, DUs, RUs, or scheduling entities shown in any of FIGS. 1-3, 9, 11, and 22. In some examples, the user equipment 804 may correspond to any of the UEs or scheduled entities shown in any of FIGS. 1-3, 9, 11, and 18.

At 806 of FIG. 8, the network entity 802 transmits (e.g., via RRC messaging) CORESET and SS configurations that the user equipment 804 is to use for receiving information from the network entity 802. For example, a CORESET configuration for the UE may specify the RBs and the number of symbols for each CORESET configured for the user equipment 804. In addition, an SS configuration may specify, for each configured SS set, the associated CORESET, PDCCH candidates, and so on.

At 808, the user equipment 804 repeatedly monitors the configured SS sets to determine whether the network entity 802 has transmitted any messages to the user equipment 804. As discussed herein, this may involve blind decoding for PDCCH candidates in a search space configured for the user equipment 804.

At 810, at some point in time, the network entity 802 schedules a PDSCH transmission for the user equipment 804. As discussed herein, a DCI may be used to inform the user equipment 804 of a scheduled transmission. Accordingly, at 812, the network entity 802 transmits a DCI to the user equipment 804 via one or more PDCCH candidates, where the DCI indicates the scheduled PDSCH transmission.

At 814, the user equipment 804 decodes the DCI. Thus, the user equipment 804 will identify the PDSCH resource (e.g., the downlink slot) that the network entity 802 will use to transmit the scheduled PDSCH transmission, along with other communication parameters (e.g., MCS, etc.) that the user equipment 804 may use to receive the PDSCH.

At 816, the network entity 802 transmit the PDSCH transmission to the user equipment 804 on the scheduled resource.

At 818, the user equipment 804 decodes the PDSCH. The user equipment 804 then sends a HARQ-Ack to the network entity 802 at 820 to indicate whether the user equipment 804 successfully received the PDSCH transmission.

As mentioned above, a network entity may transmit reference signals that a user equipment may use for various purposes. For example, a network entity may transmit a CSI-RS to a user equipment over a specified resource. The user equipment may thereby generate CSI and report the CSI back to the network entity to enable the network entity to estimate the channel over that resource. In this way, the network entity may better schedule transmissions between the network entity and the user equipment (e.g., the network entity may select the frequency band and transmission parameters the user equipment is to use to receive a downlink transmission).

A network entity may transmit CSI-RS configuration information to a user equipment that specifies the CSI-RS resources and other parameters to be used by the user equipment to measure CSI-RS and provide a corresponding CSI report. For a CSI-RS transmission, one or more CSI-RS resource sets may be configured. Each CSI-RS resource set may include CSI-RS resource parameters such as, for example, one or more ports (e.g., for a downlink beam), a number of symbols, a time domain allocation, a bandwidth, and/or other suitable parameters.

CSI reporting by a user equipment may be configured to be periodic, aperiodic, or semi-persistent. In some examples, periodic CSI reporting may be configured via a radio resource control (RRC) configuration sent by a network entity, whereby the user equipment transmits the CSI reports on the PUCCH. In some examples, semi-persistent CSI reporting may be configured via RRC signaling and triggered by a DCI sent by the network entity, whereby the user equipment transmits the CSI reports on the PUSCH. In some examples, semi-persistent CSI reporting may be activated/deactivated via medium access control-control element (MAC-CE) signaling by the network entity, whereby the user equipment transmits the CSI reports on the PUCCH. In some examples, aperiodic CSI reporting may be triggered by the network entity via a DCI, whereby the user equipment transmits the CSI report on the PUSCH.

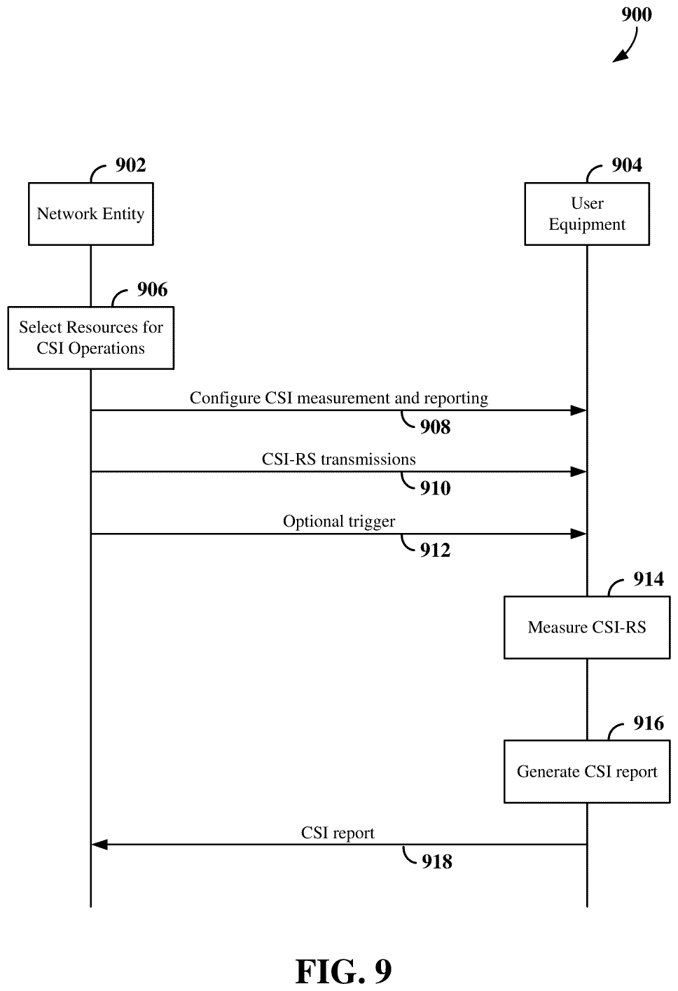

FIG. 9 is a signaling diagram 900 illustrating an example of scheduling a CSI-RS transmission in a wireless communication system including a network entity 902 and a user equipment 904. In some examples, the network entity 902 may correspond to any of the base stations, CUs, DUs, RUs, or scheduling entities shown in any of FIGS. 1-3, 8, 11, and 22. In some examples, the user equipment 904 may correspond to any of the UEs or scheduled entities shown in any of FIGS. 1-3, 8, 11, and 18.

At 906 of FIG. 9, the network entity 902 selects resources for CSI operations (e.g., CSI-RS and CSI transmissions). For example, the network entity 902 may specify resources for one or more CSI-RS resource sets to be measured by the user equipment 904, as well as resources for CSI reporting.

At 908, the network entity 902 configures CSI-related operations for the user equipment 904. For example, the network entity 902 may send an RRC message or some other type of message to the user equipment 904, where the message specifies the resources and other information to be used by the user equipment 904 for CSI-RS measurements and CSI reporting. In some examples, the network entity 902 may transmit configuration information indicating that the user equipment 904 is to perform periodic, aperiodic, or semi-persistent CSI reporting.

At 910, the network entity 902 transmits CSI-RS on the designated CSI-RS resources. At optional 912, in some examples, a DCI or other signaling may be used to trigger CSI reporting (e.g., aperiodic CSI reporting) at the user equipment 904.

At 914, the user equipment 904 measures the CSI-RS transmissions of 910 and generates CSI based on these measurements. In some examples, this CSI may include rank indicators (RI), precoding matrix indicators (PMI), channel quality information (CQI), and/or other types of information.

At 916, the user equipment 904 generates a CSI report including the CSI generated at 914. The user equipment 904 then transmits the CSI report to the network entity 902 at 918 (e.g., on uplink resources scheduled by the network entity 902 at 908).

A transmission over the channels described above may involve the use of one or more antenna ports. An antenna port is a logical entity used to map data streams to antennas. A given antenna port may drive transmissions from one or more antennas and/or resolve signal components received over one or more antennas. An antenna port may be associated with a reference signal (RS) which may allow a receiver to distinguish data streams associated with the different antenna ports in a received transmission.

Some antenna ports may be referred to as being quasi co-located, meaning that the spatial parameters of a transmission on one antenna port may be inferred from the spatial parameters of another transmission on a different antenna port. Generally speaking, two signals transmitted from the same antenna port should experience the same radio channel, whereas transmitting signals from two different antenna ports should experience different radio conditions. In some cases, transmitted signals from two different antenna ports experience radio channels having common properties. In such cases, the antenna ports are said to be in quasi co-location (QCL). Two antenna ports may be considered quasi co-located if properties of the channel over which a symbol on one antenna port is conveyed can be inferred from the channel over which a symbol on the other antenna port is conveyed. In 5G NR, scheduled entities are equipped with channel estimation, frequency offset error estimation and synchronization procedures for processing QCL. For example, if a user equipment determines that the radio channels corresponding to two different antenna ports are quasi co-located in terms of Doppler shift, then the user equipment can determine the Doppler shift for one antenna port and then apply the result on both antenna ports for channel estimation. This avoids the user equipment having to calculate Doppler shift for both antenna ports separately. Accordingly, a user equipment may be able to perform channel estimation for demodulating data or control information received from a first set of antenna ports based on reference signals received from a second set of antenna ports that are quasi co-located with the first set of antenna ports. Thus, in some examples, a QCL relationship between antenna ports may improve the chances that a user equipment may successfully decode a downlink transmission from a network entity. In some cases, a network entity may transmit, to a user equipment, an indication of which antenna ports are quasi co-located such that the user equipment may be able to identify additional reference signals to use for channel estimation.

Four types of QCL are defined in 5G NR: QCL-TypeA; QCL-TypeB; QCL-TypeC; and QCL-TypeD. QCL-TypeA may indicate a downlink reference signal (e.g., SSB or CSI-RS) or uplink reference signal (e.g., SRS) from which the large-scale channel properties (LSCPs), such as Doppler shift, Doppler spread, average delay, and/or delay spread, of a downlink channel or signal or uplink channel or signal may be inferred. QCL-TypeB and QCL-TypeC may also indicate reference signals (e.g., SSB, CSI-RS, or SRS) from which specific LSPCPs (e.g., Doppler shift and/or Doppler spread for QCL-TypeB and average delay and/or delay spread for QCL-TypeC) may be inferred. QCL-TypeD may indicate a spatial receive parameter (e.g., spatial property of the beam on which a downlink/uplink channel or signal is transmitted). The spatial property of the beam may be inferred from the beam utilized for transmission of a reference signal (e.g., SSB, CSI-RS, or SRS) and may indicate, for example, a beam direction and/or a beam width.

QCL information may be conveyed via transmission configuration indicator (TCI) states. A TCI state includes or maps to QCL relationship configurations between one or more reference signals (e.g., SSB, CSI-RS, and SRS) and downlink (DL) or uplink (UL) transmissions. For example, a TCI state may include a DL TCI for a downlink transmission, a joint DL/UL TCI, or spatial relation information for an UL transmission. A TCI state can include one or more reference signal IDs, each identifying an SSB resource, a CSI-RS resource, or an SRS resource. Each resource (SSB, CSI-RS, or SRS resource) indicates the particular beam, frequency resource, and OFDM symbol on which the corresponding reference signal is communicated. Thus, in examples in which the TCI state indicates QCL-TypeD for a downlink or uplink transmission, the reference signal ID may be utilized to identify the beam to be used for the downlink or uplink transmission based on the QCL relationship with an associated reference signal (e.g., SSB, CSI-RS, or SRS) indicated in the TCI state.

In some aspects, a network entity may configure a set of transmission configuration indication (TCI) states to indicate to a user equipment one or more QCL relationships between antenna ports used for transmitting downlink (DL) signals to the user equipment, and/or spatial transmit filter information for transmitting uplink (UL) signals from the user equipment. Each TCI state may be associated with a set of reference signals (e.g., synchronization signal blocks (SSBs) or different types of channel state information reference signals (CSI-RSs)), and the TCI state may indicate a QCL relationship between antenna ports used to transmit the set of reference signals and antenna ports used to transmit data or control information to a user equipment. As such, when a user equipment receives an indication of a particular TCI state from a network entity, the user equipment may determine that the antenna ports used to transmit the reference signals associated with the TCI state are quasi co-located with antenna ports used to transmit data and control information to the user equipment.

As mentioned above, TCI states may be used for scheduling uplink (UL) transmissions as well. For example, a network entity may configure a user equipment with a set of TCI states (e.g., via a radio resource control (RRC) message). The network entity may then specify a particular TCI state to be used for an uplink transmission (e.g., via a DCI). Various information may be specified by a given UL TCI state. For example, an uplink TCI state may specify parameters for configuring a spatial transmit filter between reference signals (RSs). In some aspects, a QCL may specify a BWP identifier, a reference signal identifier, and a QCL type.

A network entity and a user equipment may support several TCI states. A set of TCI states may be referred to as a TCI state pool or a TCI state list. In some aspects, a given TCI state may specify parameters for configuring a quasi co-location (QCL) relationship (e.g., a common beam) or a spatial transmit filter between certain uplink/downlink channels/RSs. For example, the user equipment may use the parameters specified by a given TCI state (e.g., associated with a known good beam) to configure a beam for a transmission.

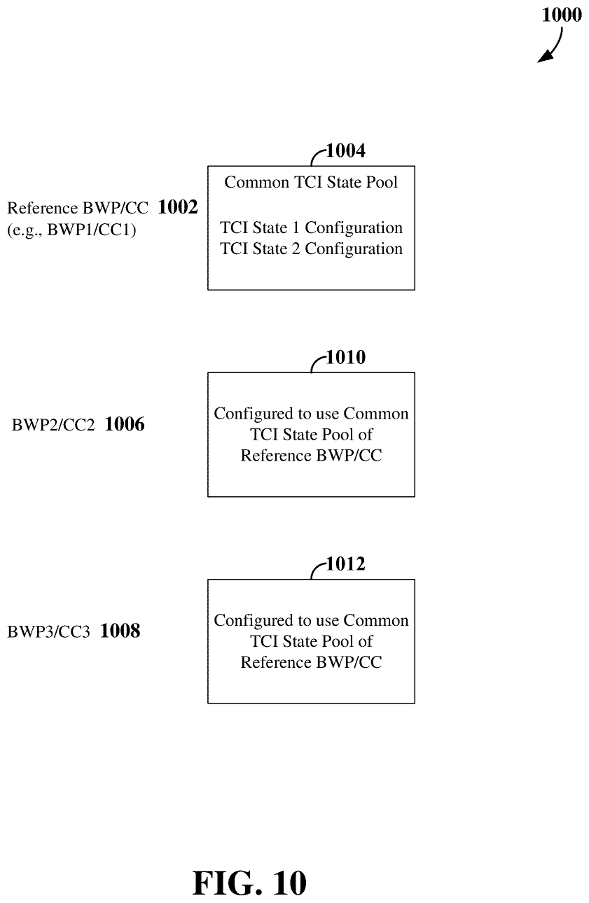

To reduce signaling overhead, a network entity may configure a common TCI state pool for multiple BWPs and CCs. For example, as shown in the diagram 1000 of FIG. 10, a network entity may designate a particular BWP and CC (e.g., BWP1/CC1) as a reference BWP/CC 1002 and configure the reference BWP/CC 1002 with a common TCI state pool 1004. The common TCI state pool 1004 includes TCI state configuration information for various TCI states (e.g., TCI state 1 configuration and TCI state 2 configuration as shown in FIG. 10). Here, the term common TCI state pool indicates that the TCI state pool is shared across multiple BWPs and CCs. For example, the network entity may configure other BWPs and CCs (e.g., a BWP2/CC2 1006 and a BWP3/CC3 1008 shown in FIG. 10) to use the common TCI state pool 1004 specified for the reference BWP/CC 1002. Thus, a configuration 1010 of the BWP2/CC2 1006 indicates that the common TCI state pool 1004 is to be used for transmissions on the BWP2/CC2 1006 and a configuration 1012 of the BWP3/CC3 1008 indicates that the common TCI state pool 1004 is to be used for transmissions on the BWP3/CC3 1008. This sharing of a common TCI state pool may reduce the amount of signaling overhead that would otherwise be used if the network entity instead signaled the TCI state pool to be used by the reference BWP/CC 1002, and signaled the TCI state pool to be used by the BWP2/CC2 1006, and signaled the TCI state pool to be used by the BWP3/CC3 1008, and so on.

Unified TCI states may be used in conjunction with such a common TCI state pool. For example, a Type 1 unified TCI state provides a joint DL/UL common TCI state to indicate a common beam for at least one DL channel/RS plus at least one UL channel/RS. As another example, a Type 3 unified TCI state provides a separate UL common TCI state to indicate a common beam for more than one UL channel/RS.

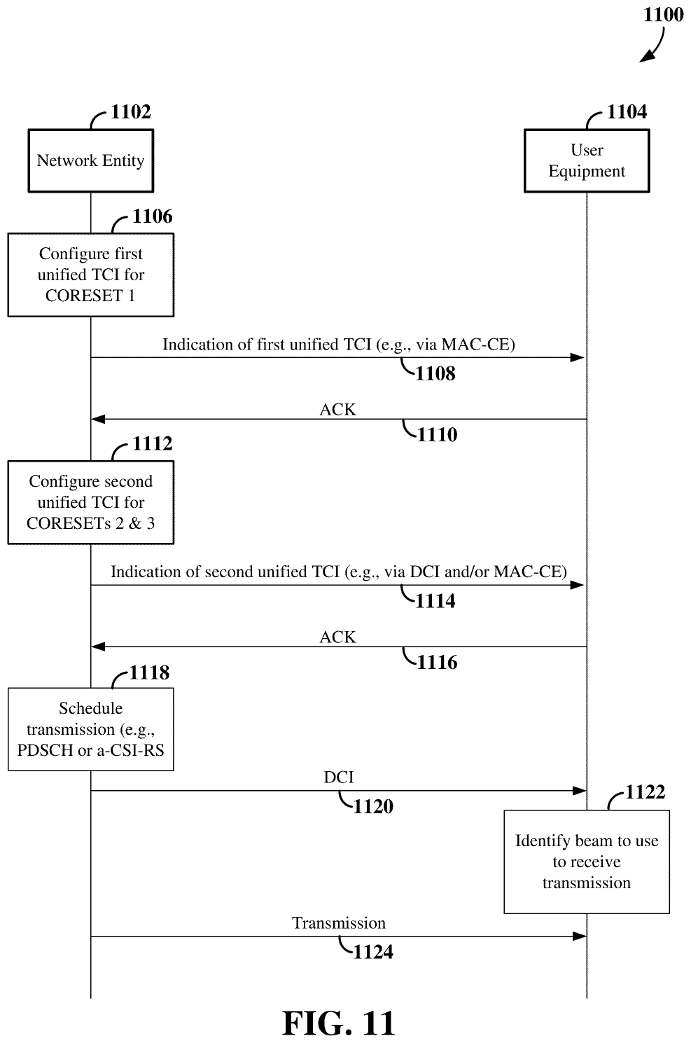

FIG. 11 is a signaling diagram 1100 illustrating an example of downlink scheduling that may use unified TCI states in a wireless communication system including a network entity 1102 and a user equipment 1104. In some examples, the network entity 1102 may correspond to any of the base stations, CUs, DUs, RUs, or scheduling entities shown in any of FIGS. 1-3, 8, 9, and 22. In some examples, the user equipment 1104 may correspond to any of the UEs or scheduled entities shown in any of FIGS. 1-3, 8, 9, and 18.

At 1106 of FIG. 11, the network entity 1102 configures a first unified TCI state for a first control resource set (CORESET 1). Thus, at 1108, the network entity 1102 sends an indication of the first unified TCI state to the user equipment 1104, where the indication specifies that the first unified TCI state is to be used to when monitoring the first control resource set. In some examples, the indication of 1108 is sent via a MAC-CE. At 1110, the user equipment 1104 acknowledges receipt of the indication of 1108.

At 1112, the network entity 1102 configures a second unified TCI state for a second control resource set (CORESET 2) and a third control resource set (CORESET 3). Thus, at 1114, the network entity 1102 sends an indication of the second unified TCI state to the user equipment 1104, where the indication specifies that the second unified TCI state is to be used to when monitoring the second control resource set and the third control resource set. In some examples, the indication of 1114 is sent via a MAC-CE. In some examples, the indication of 1114 is sent via DCI. At 1116, the user equipment 1104 acknowledges receipt of the indication of 1114.

At 1118, the network entity 1102 schedules a transmission for the user equipment 1104. In some examples, the network entity 1102 may schedule a PDSCH transmission. In some examples, the network entity 1102 may schedule an aperiodic CSI-RS transmission. In some examples, the network entity 1102 may schedule a PSSCH transmission. At 1120, the network entity 1102 transmits a DCI to the user equipment 1104 via one or more PDCCH candidates, where the DCI indicates the scheduled transmission.

In some scenarios, the DCI may include a TCI that specifies, for example, information about the beam that the user equipment 1104 may use to receive the transmission. This presence of this TCI be indicated, for example, by a tci-PresentInDCI flag in a control resource set configuration that is signaled by the network entity 1102 (e.g., in an RRC configuration message).

At 1122, the user equipment 1104 identifies a beam to be used to receive the scheduled transmission.

In scenarios where the DCI indicates a TCI state and where the user equipment 1104 is able to decode the DCI prior to receiving the schedule transmission, the user equipment 1104 may use the beam associated with (e.g., indicated by) the specified TCI to receive the scheduled transmission from the network entity 1102 at 1124. In other scenarios, however, the user equipment 1104 may use a default beam to receive the scheduled transmission from the network entity 1102 at 1124.

A user equipment might not be able to decode a received DCI in time to use a TCI included in the DCI to receive a transmission in scenarios where the scheduled transmission (e.g., PDSCH transmission) occurs “too soon” after the scheduling DCI. A transmission may be considered to be “too soon” if, for example, the transmission is scheduled in a slot that is too close in time to the slot that carries the DCI such that a user equipment that receives the DCI does not have sufficient time to decode the DCI and/or configure its receiver to use the TCI specified by the DCI. For example, a given user equipment may require a certain amount of time (e.g., corresponding to two or more slots) to decode a DCI. If a user equipment is unable to decode the DCI before the scheduled transmission arrives, the user equipment will not be able to determine which TCI the network entity designated for receiving the scheduled transmission. As another example, it may take a certain amount of time (e.g., corresponding to one or more slots) for a user equipment to reconfigure its receiver to use a new beam configuration (particularly where analog beamforming is used). If a user equipment is unable to configure its receiver to use, for example, beam and/or filter parameters specified by the TCI before the scheduled transmission arrives, the user equipment will not be able to use the configuration of that TCI to receive the scheduled transmission.

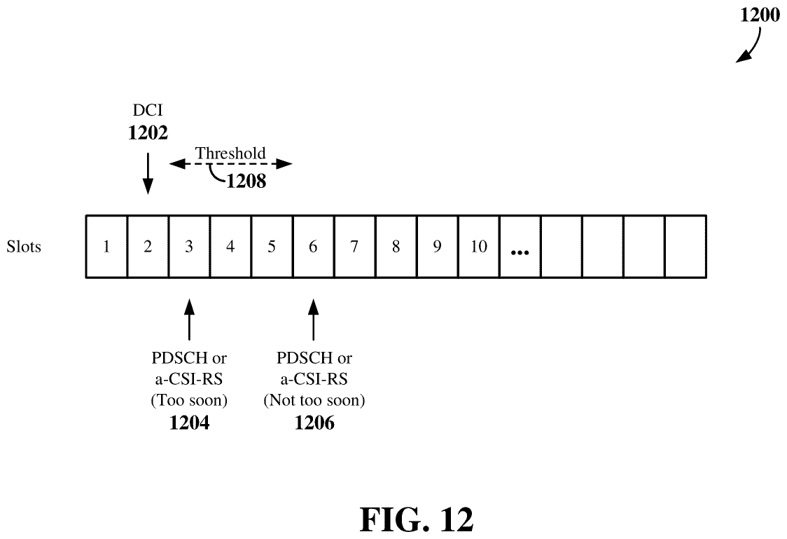

FIG. 12 illustrates an example of DCI and PDSCH timing 1200 where a DCI 1202 schedules a transmission (e.g., a PDSCH or an aperiodic CSI-RS) 1204 that occurs “too soon” after the DCI 1202, and an alternative example of a transmission 1206 that is “not too soon.” Here, “too soon” may mean that the time gap between the DCI 1208 and the transmission 1204 is less than a specified threshold duration 1208 (e.g., timeDurationForQCL). This duration may be 1 slot, 2 slots, or some other period of time.

For the “too soon” scenario of the transmission 1204, the DCI 1202 in slot 2 indicates that the transmission 1204 will follow in slot 3. Since slot 3 occurs before slot 2+the threshold duration 1208, the transmission 1204 occurs “too soon” after the DCI 1202. In this case, a user equipment may use a default beam for receiving the transmission 1204 instead of the TCI in the DCI 1202.

For the alternate “not too soon” scenario of the transmission 1206, the DCI 1202 in slot 2 indicates that the transmission 1206 will follow in slot 6. Since slot 6 occurs after slot 2+the threshold duration 1208, the transmission 1206 does not occur “too soon” after the DCI 1202. In this case, if tci-PresentInDCI is set to ‘enabled’ in the corresponding CORESET configuration, a user equipment may use the beam identifier (ID) indicated by the TCI included in the DCI 1202 to receive the transmission 1206.

The disclosure relates in some aspects to identifying a default beam (e.g., a default TCI state) to be used by a network entity to receive a transmission in the event a network entity is unable to decode a TCI in the corresponding scheduling DCI prior to the time the transmission will be received. In some examples, the transmission may be a PDSCH. In some examples, the transmission may be an aperiodic CSI-RS. In some examples, the transmission may be a PSSCH.

In some wireless communication networks, the following rule (Rule 1) may be used to determine a default beam to be used to receive a PDSCH transmission: Independent of the configuration of tci-PresentInDCI and tci-PresentDCI-1-2 in RRC connected mode, if the offset between the reception of the DL DCI and the corresponding PDSCH is less than the threshold time DurationForQCL and at least one configured TCI state for the serving cell of scheduled PDSCH contains qel-Type set to ‘typeD’,
the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

In Rule 1, in the event the offset between the reception of the DL DCI and the corresponding PDSCH is less than the threshold timeDurationForQCL, a UE may use as a default beam, the beam associated with the CORESET with the lowest CORESET ID in the latest slot within the active BWP monitored by the UE. In some scenarios, however, there may be an ambiguity as to whether the beam specified by the above rule is to be used.

For example, as discussed above in conjunction with FIG. 11, for scenarios that use unified TCI states, a unified TCI state may be indicated for multiple channels (e.g., CORESETs and PDSCHs). In some aspects, when the UE would transmit the last symbol of a PUCCH with positive acknowledgement HARQ-ACK information corresponding to the DCI carrying the TCI state indication and without downlink assignment, or corresponding to any transport-block or any code-block group scheduled by the DCI carrying the TCI state indication, and if the indicated TCI state is different from the previously indicated one, the indicated unified TCI state (e.g., DLorJointTCIState, DLorJointTCIState_r17, or UL-TCIstate) may (e.g., should) be applied starting from the first slot that is at least a specified number of symbols (e.g., BeamAppTime_r17 symbols) after the last symbol of the PUCCH. In some examples, the first slot and the BeamAppTime_r17 symbols are both determined on the carrier with the smallest SCS among the carrier(s) applying the beam indication. In some aspects, the UE may be also configured so that the CSI-RS can share the indicated unified TCI state. In some aspects, the UE may be configured with some CORESETs that are not to share the indicated unified TCI state.

In the event a DCI schedules a PDSCH for one of those channels, and the offset between the reception of the DL DCI and the corresponding PDSCH is less than the threshold time DurationForQCL, there is an ambiguity as to whether the UE should use the unified TCI state specified for the PDSCH (as the default beam) to receive a scheduled PDSCH or use the default beam associated with the CORESET of the lowest CORESET ID as specified by Rule 1. This may happen, for example, when the UE is configured with a CORESET having the lowest CORESET ID that is not to share the indicated unified TCI state.

The disclosure relates in some aspects to specifying that an indicated unified TCI state is to be used as the default beam for receiving a PDSCH transmission. The unified TCI state may be indicated by TCI indication signaling (DCI and/or MAC-CE) before the PDSCH scheduling signaling. By specifying the default beam in this way, both the network entity and the UE may select the same default beam in a scenario where the offset between the reception of the DL DCI and the corresponding PDSCH is less than the threshold time DurationForQCL.

The disclosure relates in some aspects to specifying whether or not the default PDSCH beam shares the indicated unified TCI state. In a first example, if the offset between the reception of the DL DCI and the corresponding PDSCH is less than the threshold timeDurationForQCL, a UE receives the PDSCH using the indicated unified TCI state. In a second example, if the offset between the reception of the DL DCI and the corresponding PDSCH is less than the threshold time DurationForQCL, a UE receives the PDSCH using the TCI of the CORESET having the lowest CORESET ID (pursuant to Rule 1).

In some examples, either the first example or the second example may be specified based on an RRC configuration. In some examples, either the first example or the second example may be specified based on a predetermined rule (e.g., that is configured into a UE when the UE is provisioned).

In view of the above, in some examples, the following rule (Rule 2) may be used to determine a default beam to be used to receive a PDSCH transmission: Independent of the configuration of tci-PresentInDCI and tci-PresentDCI-1-2 in RRC connected mode,
if the offset between the reception of the DL DCI and the corresponding PDSCH is less than the threshold timeDurationForQCL and at least one configured TCI state for the serving cell of scheduled PDSCH contains qcl-Type set to ‘typeD’, if the UE is not provided DLorJoint-TCIState-r17 indicating a unified TCI state, the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE.
Otherwise, if the UE is provided DLorJoint-TCIState-r17 indicating a unified TCI state, the UE may assume that the QCL parameters of PDSCH(s) of a serving cell are determined by the indicated unified TCI state.
In those cases, if the qel-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

In Rule 2, if a unified TCI state is provided for a UE, the UE may use a beam indicated by the unified TCI state as the default beam in the event the offset between the reception of the DL DCI and the corresponding PDSCH is less than the threshold timeDurationForQCL. In contrast, if a unified TCI state is not provided, in the event the offset between the reception of the DL DCI and the corresponding PDSCH is less than the threshold timeDurationForQCL, the UE may use as a default beam, the beam associated with the CORESET with the lowest CORESET ID in the latest slot within the active BWP monitored by the UE.

Referring to the example of FIG. 11, if a PDSCH transmission at 1124 is associated with the second unified TCI state (configured for CORESETs 2 and 3), the user equipment 1104 may use a beam indicated by the second unified TCI state as the default beam. In contrast, if a unified TCI state is not provided for the PDSCH transmission, the user equipment 1104 may use a beam associated with CORESET 1 (the lowest CORESET ID) as the default beam.

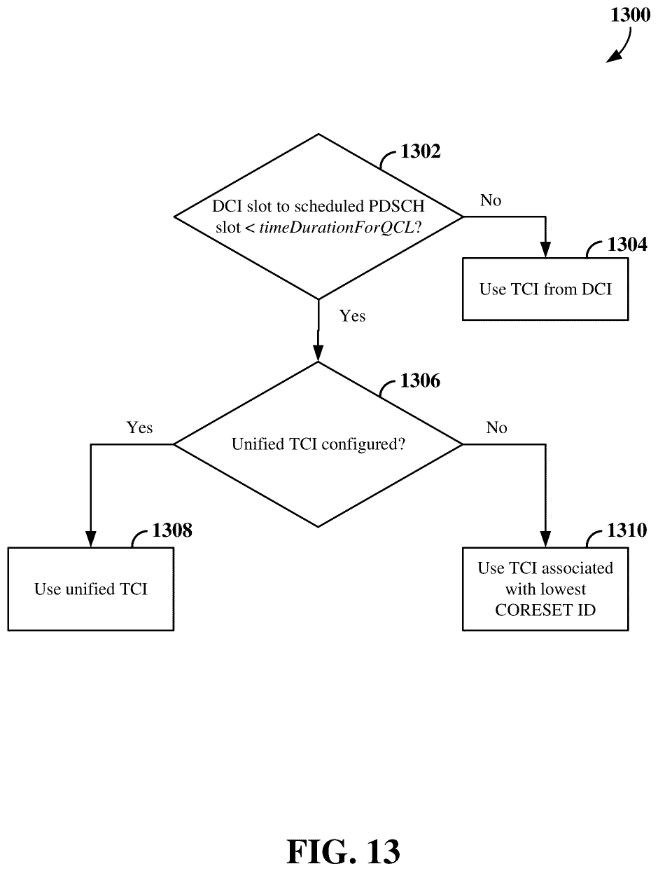

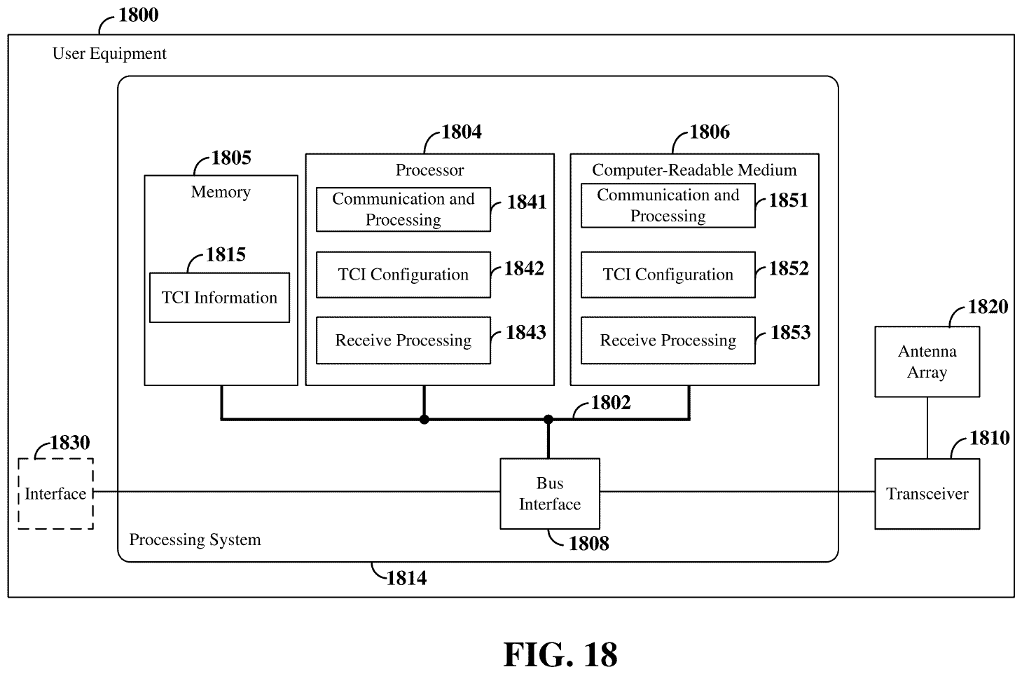

FIG. 13 is a flow chart illustrating an example method 1300 applying Rule 2 in accordance with some aspects of the present disclosure. As described below, some or all illustrated features may be omitted in a particular implementation within the scope of the present disclosure, and some illustrated features may not be required for implementation of all examples. In some examples, the method 1300 may be carried out by the UE 1800 illustrated in FIG. 18. In some examples, the method 1300 may be carried out by any suitable apparatus or means for carrying out the functions or algorithm described below.

At block 1302 of FIG. 13, a UE determines whether the amount of time between the DCI slot and the scheduled PDSCH slot is less than the timeDurationForQCL threshold. If not, at block 1304, the UE may use the TCI in the scheduling DCI since the UE would have time to decode the DCI prior to receiving the PDSCH in this case.

If, at block 1302, the UE determines that the amount of time between the DCI slot and the scheduled PDSCH slot is less than the timeDurationForQCL threshold, the operational flow proceeds to block 1306 where the UE determines whether a unified TCI state is provided for the UE. If a unified TCI state is provided, at block 1308, the UE may use a beam indicated by the unified TCI state as the default beam for receiving the PDSCH.

If, at block 1306, the UE determines that a unified TCI state is not provided for the UE, at block 1310 the UE may use as the default beam, the beam associated with the CORESET with the lowest CORESET ID in the latest slot within the active BWP monitored by the UE.

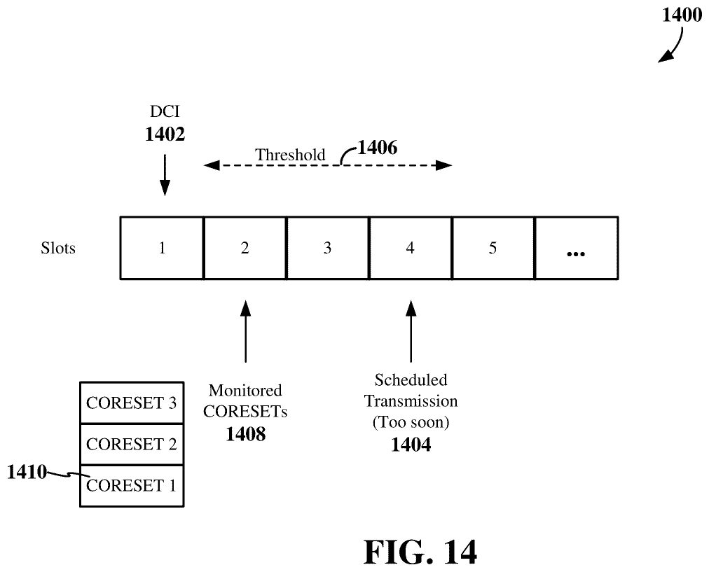

The diagram 1400 of FIG. 14 illustrates an example of a CORESET with the lowest CORESET ID in the latest slot within the active BWP monitored by the UE as described in Rule 2. A DCI 1402 in slot 1 schedules a transmission (e.g., a PDSCH) 1404 in slot 4. Since slot 4 occurs before slot 1+the threshold duration 1406 (e.g., timeDurationForQCL), the transmission 1404 occurs “too soon” after the DCI 1402. In this case, a UE may use a default beam associated with the lowest CORESET ID for receiving the transmission 1404 instead of the TCI in the DCI 1402.

FIG. 14 further illustrates an example of the latest slot (slot 2) that is associated with CORESETs 1408 that are monitored by the UE. That is, there are no monitored CORESETs associated with slot 3 in this example. The monitored CORESETs 1408 include CORESET 1, CORESET 2, and CORESET 3. Since CORESET 1 1410 has the lowest CORESET ID, the UE may use the beam associated with CORESET 1 1410 as the default beam, when applicable according to Rule 2.

In some wireless communication networks, the following rule (Rule 3) may be used to determine a default beam to be used to receive an aperiodic CSI-RS transmission: For each aperiodic CSI-RS resource in a CSI-RS resource set associated with each CSI triggering state, the UE is indicated the quasi co-location configuration of quasi co-location RS source(s) and quasi co-location type(s), through higher layer signaling of qcl-info which contains a list of references to TCI-State's for the aperiodic CSI-RS resources associated with the CSI triggering state. If a State referred to in the list is configured with a reference to an RS configured with qcl-Type set to ‘typeD’, that RS may be an SS/PBCH block located in the same or different CC/DL BWP or a CSI-RS resource configured as periodic or semi-persistent located in the same or different CC/DL BWP.
if there is any other DL signal with an indicated TCI state in the same symbols as the CSI-RS, the UE applies the QCL assumption of the other DL signal also when receiving the aperiodic CSI-RS. The other DL signal refers to PDSCH scheduled with offset larger than or equal to the threshold time DurationForQCL, periodic CSI-RS, semi-persistent CSI-RS, aperiodic CSI-RS in a NZP-CSI-RS-ResourceSet scheduled with offset larger than or equal to the UE reported threshold beamSwitchTiming when the reported value is one of the values {14,28,48}·2^{max(0, μCSIRS-3)} and when enable BeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48. 2^{max(0, μCSIRS-3)} when the UE provides beamSwitchTiming-r16 and enableBeamSwitchTiming is provided, aperiodic CSI-RS in a NZP-CSI-RS-ResourceSet configured with the higher layer parameter repetition set to ‘on’ scheduled with offset larger than or equal to the UE reported threshold beamSwitchTiming-r16 and enable BeamSwitchTiming is provided;
else if at least one CORESET is configured for the BWP in which the aperiodic CSI-RS is received, when receiving the aperiodic CSI-RS, the UE applies the QCL assumption used for the CORESET associated with a monitored search space with the lowest controlResourceSetId in the latest slot in which one or more CORESETs within the active BWP of the serving cell are monitored.

In Rule 3, in the event the offset between the reception of the DL DCI and the corresponding aperiodic CSI-RS is less than the threshold beamSwitchTiming, a UE may use as a default beam, the beam associated with another transmission, or the beam associated with the CORESET with the lowest CORESET ID in the latest slot within the active BWP monitored by the UE.

The diagram 1400 of FIG. 14 also illustrates an example of a CORESET with the lowest CORESET ID in the latest slot within the active BWP monitored by the UE as described in Rule 3. A DCI 1402 in slot 1 schedules a transmission (e.g., an aperiodic CSI-RS) 1404 in slot 4. Since slot 4 occurs before slot 1+the threshold duration 1406 (e.g., beamSwitchTiming), the transmission 1404 occurs “too soon” after the DCI 1402. In this case, a UE may use a default beam for receiving the transmission 1404 instead of the TCI in the DCI 1402.

FIG. 14 further illustrates the latest slot (slot 2) that is associated with CORESETs 1408 that are monitored by the UE, where there are no monitored CORESETs associated with slot 3 in this example. The monitored CORESETs 1408 include CORESET 1, CORESET 2, and CORESET 3. Since CORESET 1 1410 has the lowest CORESET ID, the UE may use the beam associated with CORESET 1 1410 as the default beam, when applicable according to Rule 3.

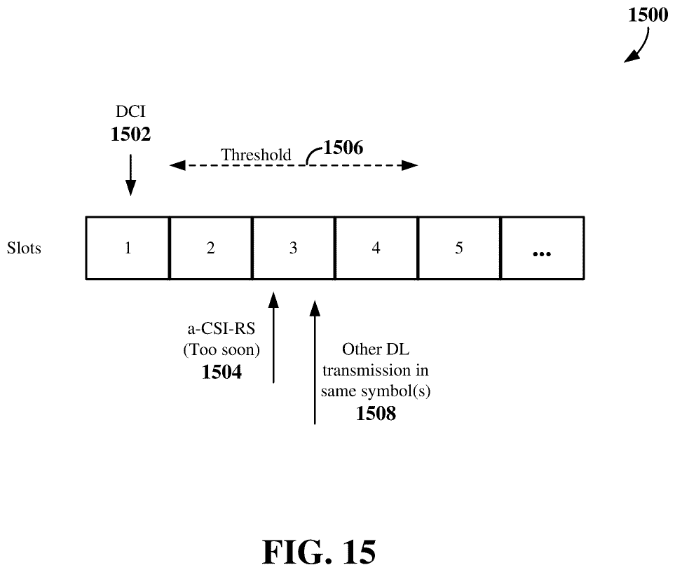

The diagram 1500 of FIG. 15 illustrates an example of another transmission as described in Rule 3. A DCI 1502 in slot 1 schedules an aperiodic CSI-RS 1504 in slot 3. Since slot 3 occurs before slot 1+the threshold duration 1506 (e.g., beamSwitchTiming), the aperiodic CSI-RS 1504 occurs “too soon” after the DCI 1502. In this case, a UE may use a default beam for receiving the aperiodic CSI-RS 1504 instead of the TCI in the DCI 1502.

FIG. 15 further illustrates an example where there is another transmission 1508 that is scheduled in at least some of the same symbols in which the aperiodic CSI-RS 1504 is scheduled. The other transmission 1508 is also associated with a TCI state. Thus, the UE may use the beam associated with the TCI state of the other transmission 1508 as the default beam, when applicable according to Rule 3.

In some scenarios, there may be an ambiguity as to whether the beam specified by Rule 3 is to be used. For example, as discussed above in conjunction with FIG. 11, for scenarios that use unified TCI states, a unified TCI state may be specified for certain channels (e.g., CORESETs and PDSCHs). In the event a DCI schedules an aperiodic CSI-RS for one of those channels, and the offset between the reception of the DL DCI and the corresponding aperiodic CSI-RS is less than the threshold beamSwitchTiming, there is an ambiguity as to whether the UE should use the unified TCI state specified for a channel (as the default beam) to receive a scheduled aperiodic CSI-RS, use the beam associated with another downlink signal, or use the default beam associated with the CORESET of the lowest CORESET ID as specified by Rule 3.

The disclosure relates in some aspects to specifying that an indicated unified TCI state is to be used as the default beam for receiving an aperiodic CSI-RS transmission. By specifying the default beam in this way, both the network entity and the UE may select the same default beam in a scenario where the offset between the reception of the DL DCI and the corresponding aperiodic CSI-RS is less than the threshold beamSwitchTiming.

The disclosure relates in some aspects to specifying whether or not the default aperiodic CSI-RS beam shares the indicated unified TCI state. In a first example, if the offset between the reception of the DL DCI and the corresponding aperiodic CSI-RS is less than the threshold beamSwitchTiming, a UE receives the aperiodic CSI-RS using the indicated unified TCI state. In a second example, if the offset between the reception of the DL DCI and the corresponding aperiodic CSI-RS is less than the threshold beamSwitchTiming, a UE receives the aperiodic CSI-RS using the TCI of the CORESET having the lowest CORESET ID, or the TCI of the other DL signal, if applicable (pursuant to Rule 3).

The first example may include a further condition. In some cases, the UE may receive the aperiodic CSI-RS using the indicated unified TCI state regardless of whether the aperiodic CSI-RS shares the indicated unified TCI state or not. That is, the UE may receive the aperiodic CSI-RS using the indicated unified TCI state as the default beam even if the aperiodic CSI-RS is not configured to share the indicated unified TCI state. In other cases, the UE may receive the aperiodic CSI-RS using the indicated unified TCI state as the default beam conditioned on the aperiodic CSI-RS sharing the indicated unified TCI state. That is, the UE may receive the aperiodic CSI-RS using the indicated unified TCI state as the default beam only if the aperiodic CSI-RS is configured to share the indicated unified TCI state.

In some examples, either the first example or the second example may be specified based on an RRC configuration. In some examples, either the first example or the second example may be specified based on a predetermined rule (e.g., that is configured into a UE when the UE is provisioned).

In view of the above, in some examples, the following rule (Rule 4) may be used to determine a default beam to be used to receive an aperiodic CSI-RS transmission: For each aperiodic CSI-RS resource in a CSI-RS resource set associated with each CSI triggering state, the UE is indicated the quasi co-location configuration of quasi co-location RS source(s) and quasi co-location type(s), through higher layer signaling of qcl-info which contains a list of references to TCI-State's for the aperiodic CSI-RS resources associated with the CSI triggering state. If a State referred to in the list is configured with a reference to an RS configured with qcl-Type set to ‘typeD’, that RS may be an SS/PBCH block located in the same or different CC/DL BWP or a CSI-RS resource configured as periodic or semi-persistent located in the same or different CC/DL BWP.
if the UE is not provided DLorJoint-TCIState-r17 indicating a unified TCI state and if there is any other DL signal with an indicated TCI state in the same symbols as the CSI-RS, the UE applies the QCL assumption of the other DL signal also when receiving the aperiodic CSI-RS. The other DL signal refers to PDSCH scheduled with offset larger than or equal to the threshold timeDurationForQCL, as defined in [13, TS 38.306], periodic CSI-RS, semi-persistent CSI-RS, aperiodic CSI-RS in a NZP-CSI-RS-ResourceSet scheduled with offset larger than or equal to the UE reported threshold beamSwitchTiming when the reported value is one of the values {14,28,48}. 2^{max(0, μCSIRS-3)} and when enableBeamSwitchTiming is not provided or the NZP-CSI-RS-ResourceSet is configured with the higher layer parameter trs-Info, aperiodic CSI-RS in a NZP-CSI-RS-ResourceSet configured with the higher layer parameter repetition set to ‘off’ or configured without the higher layer parameters repetition and trs-Info scheduled with offset larger than or equal to 48. 2^{max(0, μCSIRS-3)} when the UE provides beamSwitchTiming-r16 and enableBeamSwitchTiming is provided, aperiodic CSI-RS in a NZP-CSI-RS-ResourceSet configured with the higher layer parameter repetition set to ‘on’ scheduled with offset larger than or equal to the UE reported threshold beamSwitchTiming-r16 and enable BeamSwitchTiming is provided;
else if the UE is provided DLorJoint-TCIState-r17 indicating a unified TCI state and if there is any other DL signal sharing the indicated TCI state in the same symbols as the CSI-RS, the UE applies the QCL assumption of the indicated unified TCI state when receiving the aperiodic CSI-RS;
else if the UE is not provided DLorJoint-TCIState-r17 indicating a unified TCI state, if there is no any other DL signal in the same symbols as the CSI-RS, and if at least one CORESET is configured for the BWP in which the aperiodic CSI-RS is received, when receiving the aperiodic CSI-RS, the UE applies the QCL assumption used for the CORESET associated with a monitored search space with the lowest controlResourceSetId in the latest slot in which one or more CORESETs within the active BWP of the serving cell are monitored;
else if the UE is provided DLorJoint-TCIState-r17 indicating a unified TCI state, when receiving the aperiodic CSI-RS, the UE applies the QCL assumption used for the indicated unified TCI state.

In Rule 4, if a unified TCI state is provided for a UE, the UE may use a beam indicated by the unified TCI state as the default beam in the event the offset between the reception of the DL DCI and the corresponding aperiodic CSI-RS is less than the threshold beamSwitchTiming. However, if a unified TCI state is not provided the UE may use as a default beam, the beam associated with another transmission that has an associated TCI and is in the same symbols as the aperiodic CSI-RS. Finally, if a unified TCI state is not provided and there is no other transmission that meets the criteria of Rule 4, the UE may use as a default beam, the beam associated with the CORESET with the lowest CORESET ID in the latest slot within the active BWP monitored by the UE.

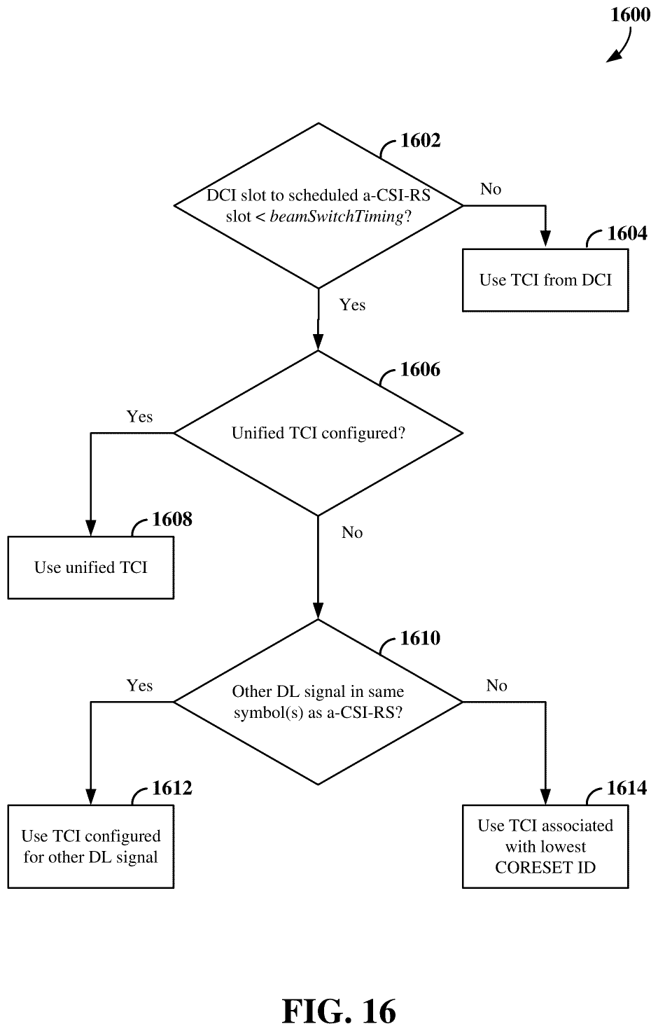

FIG. 16 is a flow chart illustrating an example method 1600 applying Rule 4 in accordance with some aspects of the present disclosure. As described below, some or all illustrated features may be omitted in a particular implementation within the scope of the present disclosure, and some illustrated features may not be required for implementation of all examples. In some examples, the method 1600 may be carried out by the UE 1800 illustrated in FIG. 18. In some examples, the method 1600 may be carried out by any suitable apparatus or means for carrying out the functions or algorithm described below.

At block 1602 of FIG. 16, a UE determines whether the amount of time between the DCI slot and the scheduled aperiodic CSI-RS slot is less than the beamSwitchTiming threshold. If not, at block 1604, the UE may use the TCI in the scheduling DCI since the UE would have time to decode the DCI prior to receiving the aperiodic CSI-RS in this ease.

If, at block 1602, the UE determines that the amount of time between the DCI slot and the scheduled aperiodic CSI-RS slot is less than the beamSwitchTiming threshold, the operational flow proceeds to block 1606 where the UE determines whether a unified TCI state is provided for the UE.

If a unified TCI state is provided, at block 1608, the UE may use a beam indicated by the unified TCI state as the default beam for receiving the aperiodic CSI-RS. In the example of FIG. 16, the use of the unified TCI state is not conditioned on the aperiodic CSI-RS sharing the unified TCI state.

If, at block 1606, the UE determines that a unified TCI state is not provided for the UE, the operational flow proceeds to block 1606 where the UE determines whether another downlink signal in the same symbol(s) as the aperiodic CSI-RS is associated with a TCI configuration. If there is such a transmission, at block 1612, the UE may use as the default beam, a beam indicated by the TCI associated with the other transmission.

If, at block 1610, the UE determines that there is no other transmission meeting the criteria of Rule 4, at block 1614, the UE may use as the default beam, the beam associated with the CORESET with the lowest CORESET ID in the latest slot within the active BWP monitored by the UE.

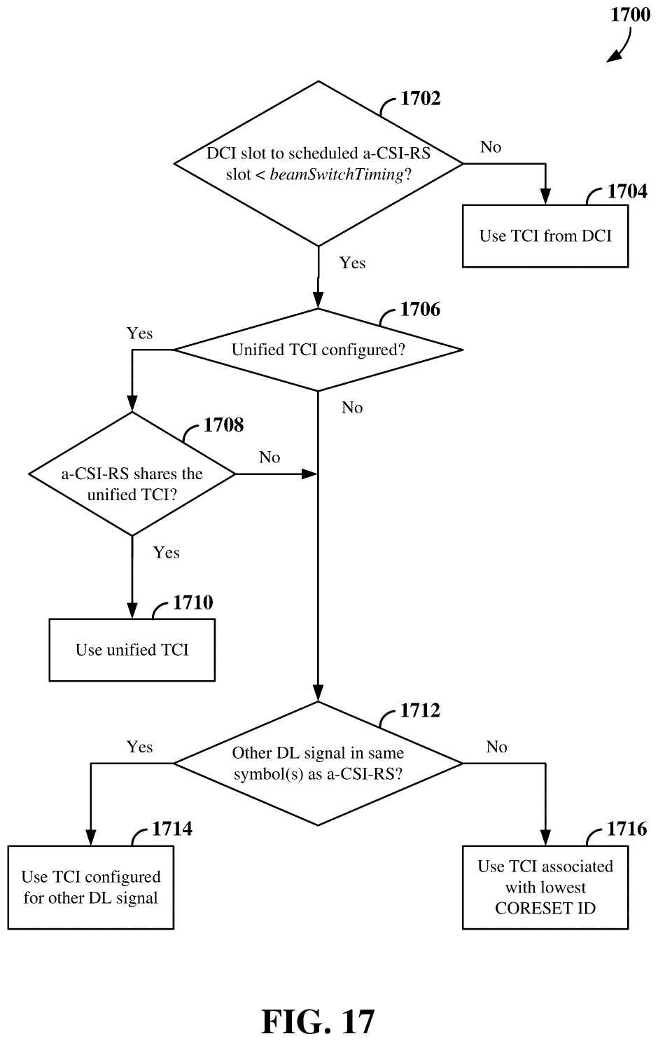

FIG. 17 is a flow chart illustrating an example method 1700 applying Rule 4 in accordance with some aspects of the present disclosure. In contrast with the method 1600 of FIG. 16, the method 1700 includes the additional condition for the indicated TCI state discussed above. As described below, some or all illustrated features may be omitted in a particular implementation within the scope of the present disclosure, and some illustrated features may not be required for implementation of all examples. In some examples, the method 1700 may be carried out by the UE 1800 illustrated in FIG. 18. In some examples, the method 1700 may be carried out by any suitable apparatus or means for carrying out the functions or algorithm described below.

At block 1702 of FIG. 17, a UE determines whether the amount of time between the DCI slot and the scheduled aperiodic CSI-RS slot is less than the beamSwitchTiming threshold. If not, at block 1704, the UE may use the TCI in the scheduling DCI since the UE would have time to decode the DCI prior to receiving the aperiodic CSI-RS in this case.

If, at block 1702, the UE determines that the amount of time between the DCI slot and the scheduled aperiodic CSI-RS slot is less than the beamSwitchTiming threshold, the operational flow proceeds to block 1706 where the UE determines whether a unified TCI state is provided for the UE.

If a unified TCI state is provided, at block 1708, the UE determines whether the aperiodic CSI-RS shares the unified TCI state. Thus, in the example of FIG. 17, the use of the unified TCI state is conditioned on the aperiodic CSI-RS sharing the unified TCI state. If the aperiodic CSI-RS shares the unified TCI state, at block 1710, the UE may use a beam indicated by the unified TCI state as the default beam for receiving the aperiodic CSI-RS. Otherwise, the operational flow proceed to block 1712.

At block 1712 (e.g., when a unified TCI state is not provided for the UE from block 1706 or the aperiodic CSI-RS does not share the unified TCI state from block 1708), the UE determines whether another downlink signal in the same symbol(s) as the aperiodic CSI-RS is associated with a TCI configuration. If there is such a transmission, at block 1714, the UE may use as the default beam, a beam indicated by the TCI associated with the other transmission.

If, at block 1712, the UE determines that there is no other transmission meeting the criteria of Rule 4, at block 1716, the UE may use as the default beam, the beam associated with the CORESET with the lowest CORESET ID in the latest slot within the active BWP monitored by the UE.

FIG. 18 is a block diagram illustrating an example of a hardware implementation for a UE 1800 employing a processing system 1814. For example, the UE 1800 may be a device configured to wirelessly communicate with a network entity, as discussed in any one or more of FIGS. 1-17. In some implementations, the UE 1800 may correspond to any of the UEs or scheduled entities shown in any of FIGS. 1-3, 8, 9, and 11.

In accordance with various aspects of the disclosure, an element, or any portion of an element, or any combination of elements may be implemented with the processing system 1814. The processing system 1814 may include one or more processors 1804. Examples of processors 1804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1800 may be configured to perform any one or more of the functions described herein. That is, the processor 1804, as utilized in a UE 1800, may be used to implement any one or more of the processes and procedures described herein.

The processor 1804 may in some instances be implemented via a baseband or modem chip and in other implementations, the processor 1804 may include a number of devices distinct and different from a baseband or modem chip (e.g., in such scenarios as may work in concert to achieve the examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1814 may be implemented with a bus architecture, represented generally by the bus 1802. The bus 1802 may include any number of interconnecting buses and bridges depending on the specific application of the processing system 1814 and the overall design constraints. The bus 1802 communicatively couples together various circuits including one or more processors (represented generally by the processor 1804), a memory 1805, and computer-readable media (represented generally by the computer-readable medium 1806). The bus 1802 may also link various other circuits such as timing sources, peripherals, voltage regulators, and power management circuits, which are well known in the art, and therefore, will not be described any further. A bus interface 1808 provides an interface between the bus 1802, a transceiver 1810 and an antenna array 1820 and between the bus 1802 and an interface 1830. The transceiver 1810 provides a communication interface or means for communicating with various other apparatus over a wireless transmission medium. The interface 1830 provides a communication interface or means of communicating with various other apparatuses and devices (e.g., other devices housed within the same apparatus as the UE 1800 or other external apparatuses) over an internal bus or external transmission medium, such as an Ethernet cable. Depending upon the nature of the apparatus, the interface 1830 may include a user interface (e.g., keypad, display, speaker, microphone, joystick). Of course, such a user interface is optional, and may be omitted in some examples, such as an IoT device.

The processor 1804 is responsible for managing the bus 1802 and general processing, including the execution of software stored on the computer-readable medium 1806. The software, when executed by the processor 1804, causes the processing system 1814 to perform the various functions described below for any particular apparatus. The computer-readable medium 1806 and the memory 1805 may also be used for storing data that is manipulated by the processor 1804 when executing software. For example, the memory 1805 may store TCI information 1815 (e.g., beam information) used by the processor 1804 for the communication operations described herein.

One or more processors 1804 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1806.

The computer-readable medium 1806 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1806 may reside in the processing system 1814, external to the processing system 1814, or distributed across multiple entities including the processing system 1814. The computer-readable medium 1806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

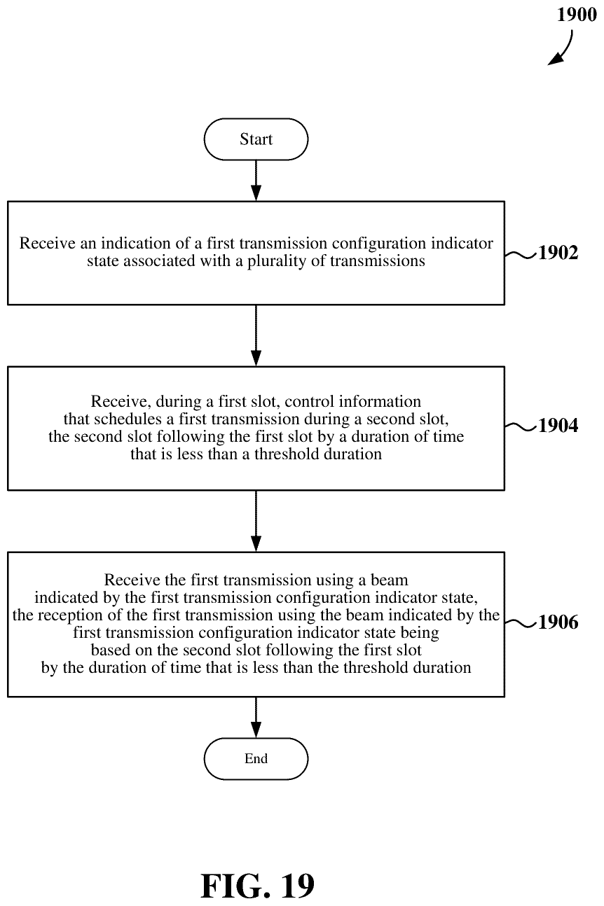

The UE 1800 may be configured to perform any one or more of the operations described herein (e.g., as described above in conjunction with FIGS. 1-17 and as described below in conjunction with FIGS. 19-21). In some aspects of the disclosure, the processor 1804, as utilized in the UE 1800, may include circuitry configured for various functions.

The processor 1804 may include communication and processing circuitry 1841. The communication and processing circuitry 1841 may be configured to communicate with a network entity, such as a gNB. The communication and processing circuitry 1841 may be configured to communicate with a base station and one or more other wireless communication devices over a common carrier shared between a cellular (e.g., Uu) interface and a sidelink (e.g., PC5) interface. The communication and processing circuitry 1841 may include one or more hardware components that provide the physical structure that performs various processes related to wireless communication (e.g., signal reception and/or signal transmission) as described herein. The communication and processing circuitry 1841 may further include one or more hardware components that provide the physical structure that performs various processes related to signal processing (e.g., processing a received signal and/or processing a signal for transmission) as described herein. In some examples, the communication and processing circuitry 1841 may include two or more transmit/receive chains (e.g., one chain to communicate with a base station and another chain to communicate with a sidelink device). The communication and processing circuitry 1841 may further be configured to execute communication and processing software 1851 included on the computer-readable medium 1806 to implement one or more functions described herein.

In some implementations where the communication involves receiving information, the communication and processing circuitry 1841 may obtain information from a component of the UE 1800 (e.g., from the transceiver 1810 that receives the information via radio frequency signaling or some other type of signaling suitable for the applicable communication medium), process (e.g., decode) the information, and output the processed information. For example, the communication and processing circuitry 1841 may output the information to another component of the processor 1804, to the memory 1805, or to the bus interface 1808. In some examples, the communication and processing circuitry 1841 may receive one or more of signals, messages, other information, or any combination thereof. In some examples, the communication and processing circuitry 1841 may receive information via one or more channels. In some examples, the communication and processing circuitry 1841 may receive one or more of signals, messages, SCIs, feedback, other information, or any combination thereof. In some examples, the communication and processing circuitry 1841 may receive information via one or more of a PSCCH, a PSSCH, a PSFCH, some other type of channel, or any combination thereof. In some examples, the communication and processing circuitry 1841 may include functionality for a means for receiving. In some examples, the communication and processing circuitry 1841 may include functionality for a means for decoding.

In some implementations where the communication involves sending (e.g., transmitting) information, the communication and processing circuitry 1841 may obtain information (e.g., from another component of the processor 1804, the memory 1805, or the bus interface 1808), process (e.g., encode) the information, and output the processed information. For example, the communication and processing circuitry 1841 may output the information to the transceiver 1810 (e.g., that transmits the information via radio frequency signaling or some other type of signaling suitable for the applicable communication medium). In some examples, the communication and processing circuitry 1841 may send one or more of signals, messages, other information, or any combination thereof. In some examples, the communication and processing circuitry 1841 may send information via one or more channels. In some examples, the communication and processing circuitry 1841 may send one or more of signals, messages, SCIs, feedback, other information, or any combination thereof. In some examples, the communication and processing circuitry 1841 may send information via one or more of a PSCCH, a PSSCH, a PSFCH, some other type of channel, or any combination thereof. In some examples, the communication and processing circuitry 1841 may include functionality for a means for sending (e.g., a means for transmitting). In some examples, the communication and processing circuitry 1841 may include functionality for a means for encoding.

The processor 1804 may include TCI configuration circuitry 1842 configured to perform TCI configuration-related operations as discussed herein (e.g., one or more of the operations described above in conjunction with FIGS. 8-17). The TCI configuration circuitry 1842 may be configured to execute TCI configuration software 1852 included on the computer-readable medium 1806 to implement one or more functions described herein.

The TCI configuration circuitry 1842 may include functionality for a means for receiving an indication of a TCI state (e.g., as described above in conjunction with FIGS. 8-17). For example, the TCI configuration circuitry 1842 together with the communication and processing circuitry 1841 and the transceiver 1810 may receive an RRC message on a PDSCH that identifies one or more unified TCI states and/or includes other TCI configuration information.

The processor 1804 may include receive processing circuitry 1843 configured to perform receive processing-related operations as discussed herein (e.g., one or more of the operations described above in conjunction with FIGS. 8-17). The receive processing circuitry 1843 may be configured to execute receive processing software 1853 included on the computer-readable medium 1806 to implement one or more functions described herein.

The receive processing circuitry 1843 may include functionality for a means for receiving DCI. For example, the receive processing circuitry 1843 may monitor a search space for PDCCH transmissions by a gNB or some other network entity.

The receive processing circuitry 1843 may include functionality for a means for receiving a transmission. For example, the receive processing circuitry 1843 may monitor a scheduled downlink resource for PDSCH transmissions and/or aperiodic CSI-RS transmissions by a gNB or some other network entity.

FIG. 19 is a flow chart illustrating an example method 1900 for a user equipment in accordance with some aspects of the present disclosure. As described below, some or all illustrated features may be omitted in a particular implementation within the scope of the present disclosure, and some illustrated features may not be required for implementation of all examples. In some examples, the method 1900 may be carried out by the UE 1800 illustrated in FIG. 18. In some examples, the method 1900 may be carried out by any suitable apparatus or means for carrying out the functions or algorithm described below.

At block 1902, a user equipment may receive an indication of a first transmission configuration indicator state associated with a plurality of transmissions. In some examples, the TCI configuration circuitry 1842 in cooperation with the communication and processing circuitry 1841 and the transceiver 1810, shown and described in FIG. 18, may provide a means to an indication of a first transmission configuration indicator state associated with a plurality of transmissions.

At block 1904, the user equipment may receive, during a first slot, control information that schedules a first transmission during a second slot, the second slot following the first slot by a duration of time that is less than a threshold duration. In some examples, the receive processing circuitry 1843 in cooperation with the communication and processing circuitry 1841 and the transceiver 1810, shown and described in FIG. 18, may provide a means to receive, during a first slot, control information that schedules a first transmission during a second slot.

At block 1906, the user equipment may receive the first transmission using a beam indicated by the first transmission configuration indicator state, the reception of the first transmission using the beam indicated by the first transmission configuration indicator state being based on the second slot following the first slot by the duration of time that is less than the threshold duration. In some examples, the receive processing circuitry 1843 in cooperation with the communication and processing circuitry 1841 and the transceiver 1810, shown and described in FIG. 18, may provide a means to receive the first transmission using a beam indicated by the first transmission configuration indicator state.

In some examples, the control information may be downlink control information. In some examples, the first transmission may be a physical downlink shared channel transmission. In some examples, the first transmission may be a physical sidelink shared channel transmission. In some examples, the threshold duration specifies a minimum decoding time (e.g., for the physical downlink shared channel transmission). In some examples, the threshold duration may include a timeDurationForQCL threshold. In some examples, the user equipment may identify quasi co-location parameters for receiving the physical downlink shared channel transmission based on the first transmission configuration indicator state.

In some examples, the first transmission may include an aperiodic channel state information reference signal transmission. In some examples, the threshold duration specifies a minimum decoding time (e.g., for the aperiodic channel state information reference signal transmission). In some examples, the threshold duration may include a beamSwitchTiming threshold. In some examples, the user equipment may identify quasi co-location parameters for receiving the aperiodic channel state information reference signal transmission based on the first transmission configuration indicator state. In some examples, the user equipment may receive the first transmission using the beam indicated by the first transmission configuration indicator state based on the aperiodic channel state information reference signal transmission being configured to use the first transmission configuration indicator state. In some examples, the user equipment may receive the first transmission using the beam indicated by the first transmission configuration indicator state irrespective of whether the aperiodic channel state information reference signal transmission is configured to use the first transmission configuration indicator state. In some examples, the user equipment may receive the first transmission using the beam indicated by the first transmission configuration indicator state based on an absence of a second transmission scheduled, at least in part, during the second slot, and configured to use a transmission configuration indicator state.

In some examples, the user equipment may receive a radio resource control configuration specifying that the user equipment is to receive transmissions using beams indicated by at least one transmission configuration indicator state if the user equipment has been configured with the at least one transmission configuration indicator state. In some examples, the user equipment may be configured with a rule specifying that the user equipment is to receive transmissions using beams indicated by at least one transmission configuration indicator state if the user equipment has been configured with the at least one transmission configuration indicator state.

In some examples, the user equipment may receive the indication of the first transmission configuration indicator state via the control information. In some examples, the user equipment may receive the indication of the first transmission configuration indicator state via a medium access control-control element.

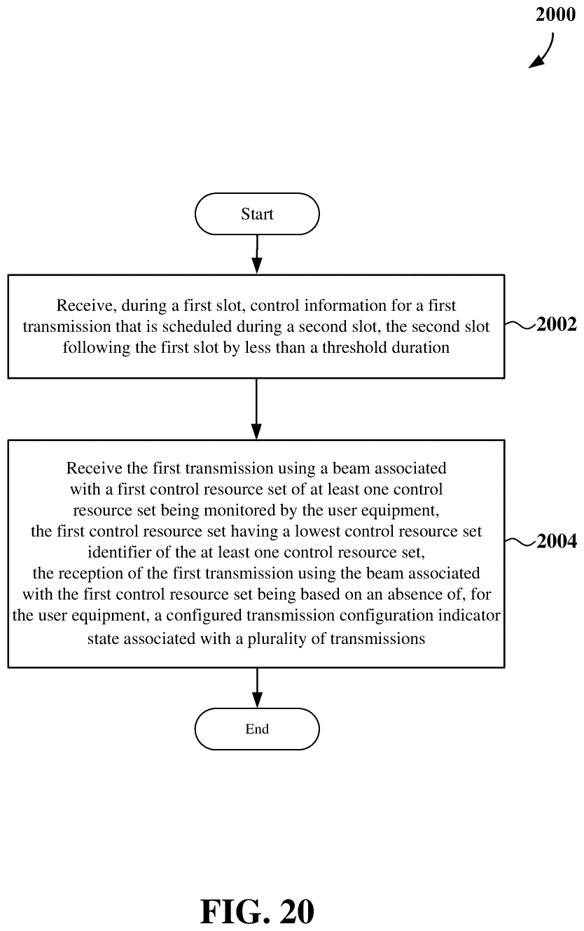

FIG. 20 is a flow chart illustrating an example method 2000 for a user equipment in accordance with some aspects of the present disclosure. As described below, some or all illustrated features may be omitted in a particular implementation within the scope of the present disclosure, and some illustrated features may not be required for implementation of all examples. In some examples, the method 2000 may be carried out by the UE 1800 illustrated in FIG. 18. In some examples, the method 2000 may be carried out by any suitable apparatus or means for carrying out the functions or algorithm described below.

At block 2002, a user equipment may receive, during a first slot, control information that schedules a first transmission during a second slot, the second slot following the first slot by a duration of time that is less than a threshold duration. In some examples, the receive processing circuitry 1843 in cooperation with the communication and processing circuitry 1841 and the transceiver 1810, shown and described in FIG. 18, may provide a means to receive, during a first slot, control information that schedules a first transmission during a second slot.

At block 2004, the user equipment may receive the first transmission using a beam associated with a first control resource set of at least one control resource set being monitored by the user equipment, the first control resource set having a lowest control resource set identifier of the at least one control resource set, the reception of the first transmission using the beam associated with the first control resource set being based on an absence of, for the user equipment, a configured transmission configuration indicator state associated with a plurality of transmissions. In some examples, the receive processing circuitry 1843 in cooperation with the communication and processing circuitry 1841 and the transceiver 1810, shown and described in FIG. 18, may provide a means to receive the first transmission using a beam associated with a first control resource set of at least one control resource set being monitored by the user equipment.

In some examples, the at least one control resource set is associated with a first search space of an active bandwidth part of a serving cell for the user equipment that is being monitored by the user equipment. In some examples, the at least one control resource set is associated with a third slot that precedes the second slot and is closer to the second slot than any other slot associated with the first search space. In some examples, the beam is indicated by a transmission configuration indicator for the first control resource set.

In some examples, the control information may be downlink control information. In some examples, the first transmission may be a physical downlink shared channel transmission. In some examples, the first transmission may be a physical sidelink shared channel transmission. In some examples, the threshold duration specifies a minimum decoding time (e.g., for the physical downlink shared channel transmission). In some examples, the threshold duration may include a timeDurationForQCL threshold.

In some examples, the first transmission may include an aperiodic channel state information reference signal transmission. In some examples, the threshold duration specifies a minimum decoding time (e.g., for the aperiodic channel state information reference signal transmission). In some examples, the threshold duration may include a beamSwitchTiming threshold.

In some examples, the user equipment may receive the first transmission using the beam associated with the first control resource set based on an absence of a second transmission scheduled, at least in part, during the second slot, and configured to use a transmission configuration indicator state.

In some examples, the user equipment may receive a radio resource control configuration specifying that the user equipment is to receive transmissions using beams indicated by lowest control resource set identifiers if the user equipment has not been configured with at least one transmission configuration indicator state. In some examples, the user equipment may be configured with a rule specifying that the user equipment is to receive transmissions using beams indicated by lowest control resource set identifiers if the user equipment has not been configured with at least one transmission configuration indicator state.

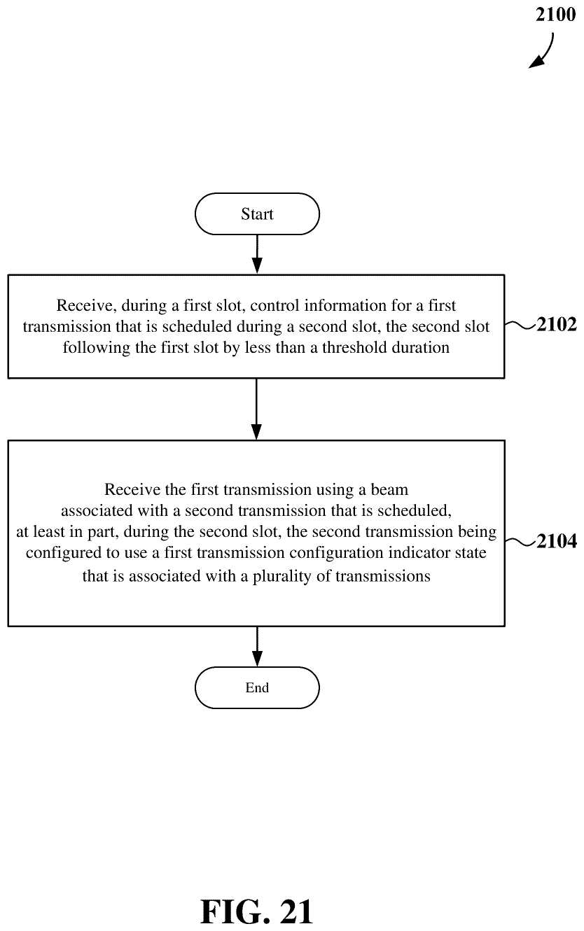

FIG. 21 is a flow chart illustrating an example method 2100 for a user equipment in accordance with some aspects of the present disclosure. As described below, some or all illustrated features may be omitted in a particular implementation within the scope of the present disclosure, and some illustrated features may not be required for implementation of all examples. In some examples, the method 2100 may be carried out by the UE 1800 illustrated in FIG. 18. In some examples, the method 2100 may be carried out by any suitable apparatus or means for carrying out the functions or algorithm described below.

At block 2102, a user equipment may receive, during a first slot, control information that schedules a first transmission during a second slot, the second slot following the first slot by a duration of time that is less than a threshold duration. In some examples, the receive processing circuitry 1843 in cooperation with the communication and processing circuitry 1841 and the transceiver 1810, shown and described in FIG. 18, may provide a means to receive, during a first slot, control information that schedules a first transmission during a second slot.

At block 2104, the user equipment may receive the first transmission using a beam associated with a second transmission that is scheduled, at least in part, during the second slot, the second transmission being configured to use a first transmission configuration indicator state that is associated with a plurality of transmissions. In some examples, the receive processing circuitry 1843 in cooperation with the communication and processing circuitry 1841 and the transceiver 1810, shown and described in FIG. 18, may provide a means to receive the first transmission using a beam associated with a second transmission that is scheduled, at least in part, during the second slot.

In some examples, the control information may be downlink control information. In some examples, the first transmission may be a physical sidelink shared channel transmission. In some examples, the first transmission may include an aperiodic channel state information reference signal transmission. In some examples, the threshold duration specifies a minimum decoding time (e.g., for the aperiodic channel state information reference signal transmission). In some examples, the threshold duration may include a beamSwitchTiming threshold. In some examples, the user equipment is configured to identify quasi co-location parameters for receiving the aperiodic channel state information reference signal transmission based on the first transmission configuration indicator state.

In some examples, the user equipment is configured to receive the first transmission using the beam associated with a second transmission based on an absence of a configured transmission configuration indicator state for the user equipment.

In some examples, the user equipment is configured to receive a radio resource control configuration specifying that the user equipment is to receive transmissions using beams associated with other transmissions if the user equipment has not been configured with at least one transmission configuration indicator state.

In some examples, the user equipment is configured with a rule specifying that the user equipment is to receive transmissions using beams associated with other transmissions if the user equipment has not been configured with at least one transmission configuration indicator state.

In one configuration, the UE 1800 includes means for receiving an indication of a first transmission configuration indicator state associated with a plurality of transmissions, means for receiving, during a first slot, control information that schedules a first transmission during a second slot, the second slot following the first slot by a duration of time that is less than a threshold duration, and means for receiving the first transmission using a beam indicated by the first transmission configuration indicator state, the receiving the first transmission using the beam indicated by the first transmission configuration indicator state being based on the second slot following the first slot by the duration of time that is less than the threshold duration. In one configuration, the UE 1800 includes means for receiving, during a first slot, control information for a first transmission that is scheduled during a second slot, the second slot following the first slot by less than a threshold duration, and means for receiving the first transmission using a beam associated with a first control resource set of at least one control resource set being monitored by the user equipment, the first control resource set having a lowest control resource set identifier of the at least one control resource set, the receiving the first transmission using the beam associated with the first control resource set being based on an absence of, for the user equipment, a configured transmission configuration indicator state associated with a plurality of transmissions. In one configuration, the UE 1800 includes means for receiving, during a first slot, control information for a first transmission that is scheduled during a second slot, the second slot following the first slot by less than a threshold duration, and means for receiving the first transmission using a beam associated with a second transmission that is scheduled, at least in part, during the second slot, the second transmission being configured to use a first transmission configuration indicator state that is associated with a plurality of transmissions. In one aspect, the aforementioned means may be the processor 1804 shown in FIG. 18 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable medium 1806, or any other suitable apparatus or means described in any one or more of FIGS. 1, 2, 3, 8, 9, and 11, and 18, and utilizing, for example, the methods and/or algorithms described herein in relation to FIGS. 19-21.

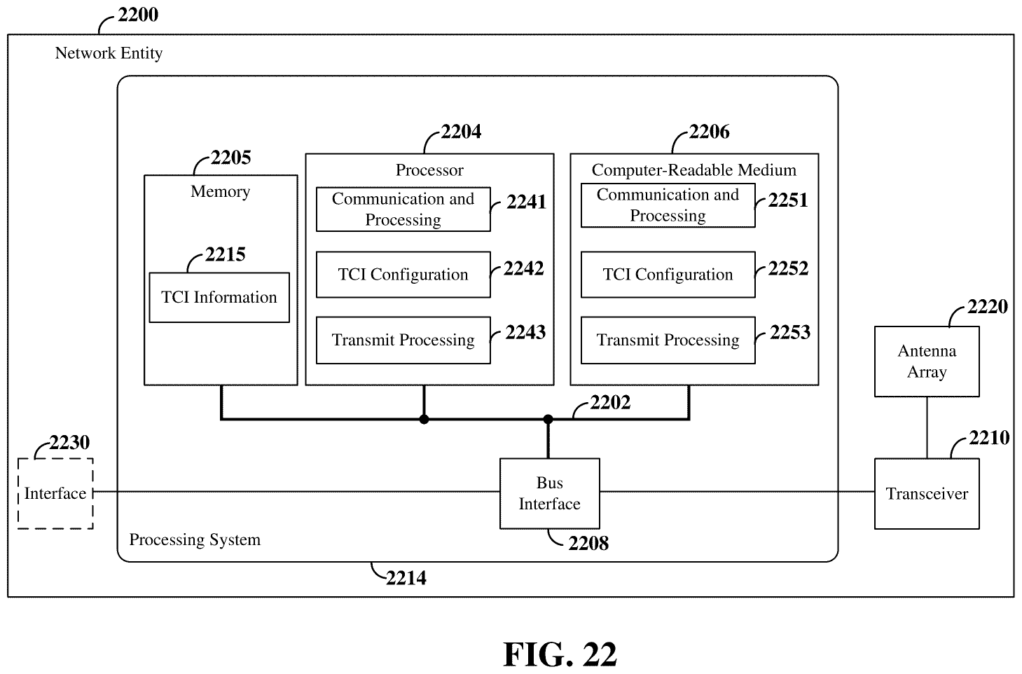

FIG. 22 is a conceptual diagram illustrating an example of a hardware implementation for a network entity 2200 employing a processing system 2214. In some implementations, the network entity 2200 may correspond to any of the base stations, CUs, DUs, RUs, or scheduling entities shown in any of FIGS. 1-3, 8, 9, and 11.

In accordance with various aspects of the disclosure, an element, or any portion of an element, or any combination of elements may be implemented with the processing system 2214. The processing system may include one or more processors 2204. The processing system 2214 may be substantially the same as the processing system 1814 illustrated in FIG. 18, including a bus interface 2208, a bus 2202, memory 2205, a processor 2204, a computer-readable medium 2206, a transceiver 2210, and an antenna array 2220. The memory 2205 may store TCI information 2215 (e.g., beam information) used by the processor 2204 in cooperation with the transceiver 2210 for communication operations as described herein. Furthermore, the network entity 2200 may include an interface 2230 (e.g., a network interface) that provides a means for communicating with at least one other apparatus within a core network and with at least one radio access network.

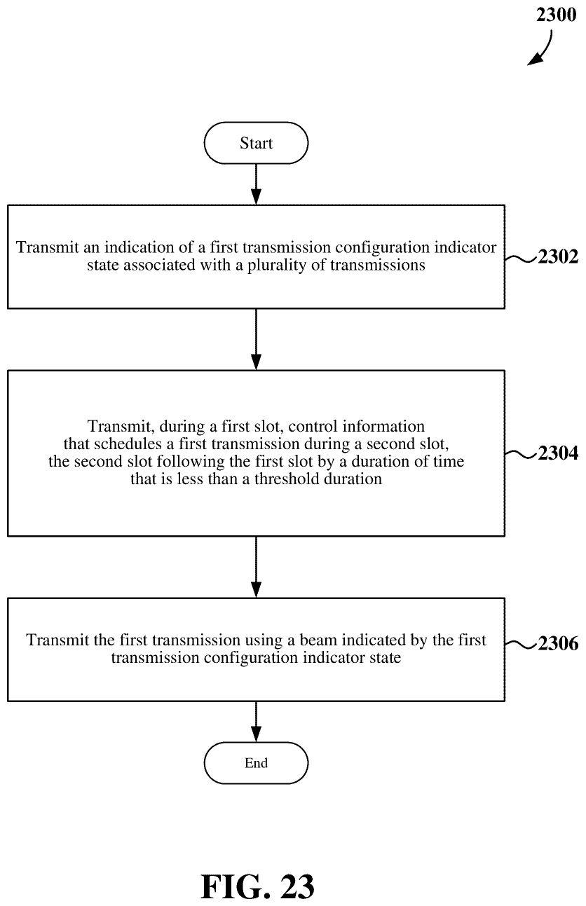

The network entity 2200 may be configured to perform any one or more of the operations described herein (e.g., as described above in conjunction with FIGS. 1-17 and as described below in conjunction with FIGS. 23-25). In some aspects of the disclosure, the processor 2204, as utilized in the network entity 2200, may include circuitry configured for various functions.

The processor 2204 may be configured to generate, schedule, and modify a resource assignment or grant of time-frequency resources (e.g., a set of one or more resource elements). For example, the processor 2204 may schedule time-frequency resources within a plurality of time division duplex (TDD) and/or frequency division duplex (FDD) subframes, slots, and/or mini-slots to carry user data traffic and/or control information to and/or from multiple scheduled entities. The processor 2204 may be configured to schedule resources for the transmission of downlink signals. The processor 2204 may further be configured to schedule resources for the transmission of uplink signals.

In some aspects of the disclosure, the processor 2204 may include communication and processing circuitry 2241. The communication and processing circuitry 2241 may be configured to communicate with a user equipment. The communication and processing circuitry 2241 may include one or more hardware components that provide the physical structure that performs various processes related to communication (e.g., signal reception and/or signal transmission) as described herein. The communication and processing circuitry 2241 may further include one or more hardware components that provide the physical structure that performs various processes related to signal processing (e.g., processing a received signal and/or processing a signal for transmission) as described herein. The communication and processing circuitry 2241 may further be configured to execute communication and processing software 2251 included on the computer-readable medium 2206 to implement one or more functions described herein.

The communication and processing circuitry 2241 may further be configured to receive an indication from the UE. For example, the indication may be included in a MAC-CE carried in a Uu PUSCH or a PSCCH, or included in a Uu RRC message or an SL RRC message, or included in a dedicated Uu PUCCH or PUSCH. The communication and processing circuitry 2241 may further be configured to receive a scheduling request from a UE for an uplink grant or a sidelink grant.

In some implementations wherein the communication involves receiving information, the communication and processing circuitry 2241 may obtain information from a component of the network entity 2200 (e.g., from the transceiver 2210 that receives the information via radio frequency signaling or some other type of signaling suitable for the applicable communication medium), process (e.g., decode) the information, and output the processed information. For example, the communication and processing circuitry 2241 may output the information to another component of the processor 2204, to the memory 2205, or to the bus interface 2208. In some examples, the communication and processing circuitry 2241 may receive one or more of signals, messages, other information, or any combination thereof. In some examples, the communication and processing circuitry 2241 may receive information via one or more channels. In some examples, the communication and processing circuitry 2241 may include functionality for a means for receiving. In some examples, the communication and processing circuitry 2241 may include functionality for a means for decoding.

In some implementations wherein the communication involves sending (e.g., transmitting) information, the communication and processing circuitry 2241 may obtain information (e.g., from another component of the processor 2204, the memory 2205, or the bus interface 2208), process (e.g., encode) the information, and output the processed information. For example, the communication and processing circuitry 2241 may output the information to the transceiver 2210 (e.g., that transmits the information via radio frequency signaling or some other type of signaling suitable for the applicable communication medium). In some examples, the communication and processing circuitry 2241 may send one or more of signals, messages, other information, or any combination thereof. In some examples, the communication and processing circuitry 2241 may send information via one or more channels. In some examples, the communication and processing circuitry 2241 may include functionality for a means for sending (e.g., a means for transmitting). In some examples, the communication and processing circuitry 2241 may include functionality for a means for encoding.

The processor 2204 may include TCI configuration circuitry 2242 configured to perform TCI configuration-related operations as discussed herein (e.g., one or more of the operations described above in conjunction with FIGS. 8-17). The TCI configuration circuitry 2242 may be configured to execute TCI configuration software 2252 included on the computer-readable medium 2206 to implement one or more functions described herein.

The TCI configuration circuitry 2242 may include functionality for a means for transmitting an indication of a TCI state (e.g., as described above in conjunction with FIGS. 8-17). For example, the TCI configuration circuitry 2242 together with the communication and processing circuitry 2241 and the transceiver 2210 may transmit an RRC message on a PDSCH that identifies one or more unified TCI states and/or includes other TCI configuration information.

The processor 2204 may include transmit processing circuitry 2243 configured to perform transmit processing-related operations as discussed herein (e.g., one or more of the operations described above in conjunction with FIGS. 8-17). The transmit processing circuitry 2243 may be configured to execute transmit processing software 2253 included on the computer-readable medium 2206 to implement one or more functions described herein.

The transmit processing circuitry 2243 may include functionality for a means for transmitting a DCI (e.g., as described above in conjunction with FIGS. 8-17). For example, the transmit processing circuitry 2244 may transmit PDCCH transmissions to a UE on a search space configured for the UE.

The transmit processing circuitry 2243 may include functionality for a means for transmitting a transmission. For example, the transmit processing circuitry 1243 may transmit PDSCH transmissions and/or aperiodic CSI-RS transmissions on resources scheduled by a DCI.

FIG. 23 is a flow chart illustrating an example method 2300 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 2300 may be carried out by the network entity 2200 illustrated in FIG. 22. In some examples, the method 2300 may be carried out by any suitable apparatus or means for carrying out the functions or algorithm described below.

At block 2302, a network entity may transmit an indication of a first transmission configuration indicator state associated with a plurality of transmissions. In some examples, the TCI configuration circuitry 2242 in cooperation with the communication and processing circuitry 2241 and the transceiver 2210, shown and described in FIG. 22, may provide a means to transmit an indication of a first transmission configuration indicator state associated with a plurality of transmissions.

At block 2304, the network entity may transmit, during a first slot, control information that schedules a first transmission during a second slot, the second slot following the first slot by a duration of time that is less than a threshold duration. In some examples, the transmit processing circuitry 2243 in cooperation with the communication and processing circuitry 2241 and the transceiver 2210, shown and described in FIG. 22, may provide a means to transmit, during a first slot, control information that schedules a first transmission during a second slot.

At block 2306, the network entity may transmit the first transmission using a beam indicated by the first transmission configuration indicator state. In some examples, the transmit processing circuitry 2243 in cooperation with the communication and processing circuitry 2241 and the transceiver 2210, shown and described in FIG. 22, may provide a means to transmit the first transmission using a beam indicated by the first transmission configuration indicator state.

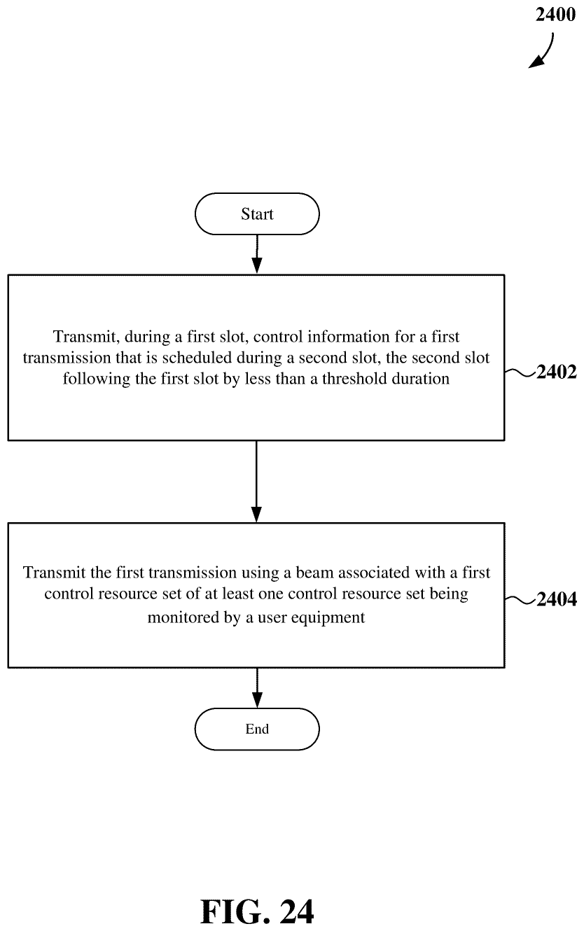

FIG. 24 is a flow chart illustrating an example method 2400 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 2400 may be carried out by the network entity 2200 illustrated in FIG. 22. In some examples, the method 2400 may be carried out by any suitable apparatus or means for carrying out the functions or algorithm described below.

At block 2402, a network entity may transmit, during a first slot, control information that schedules a first transmission during a second slot, the second slot following the first slot by a duration of time that is less than a threshold duration. In some examples, the transmit processing circuitry 2243 in cooperation with the communication and processing circuitry 2241 and the transceiver 2210, shown and described in FIG. 22, may provide a means to transmit, during a first slot, control information that schedules a first transmission during a second slot.

At block 2404, the network entity may transmit the first transmission using a beam associated with a first control resource set of at least one control resource set being monitored by a user equipment. In some examples, the transmit processing circuitry 2243 in cooperation with the communication and processing circuitry 2241 and the transceiver 2210, shown and described in FIG. 22, may provide a means to transmit the first transmission using a beam associated with a first control resource set of at least one control resource set being monitored by the user equipment.

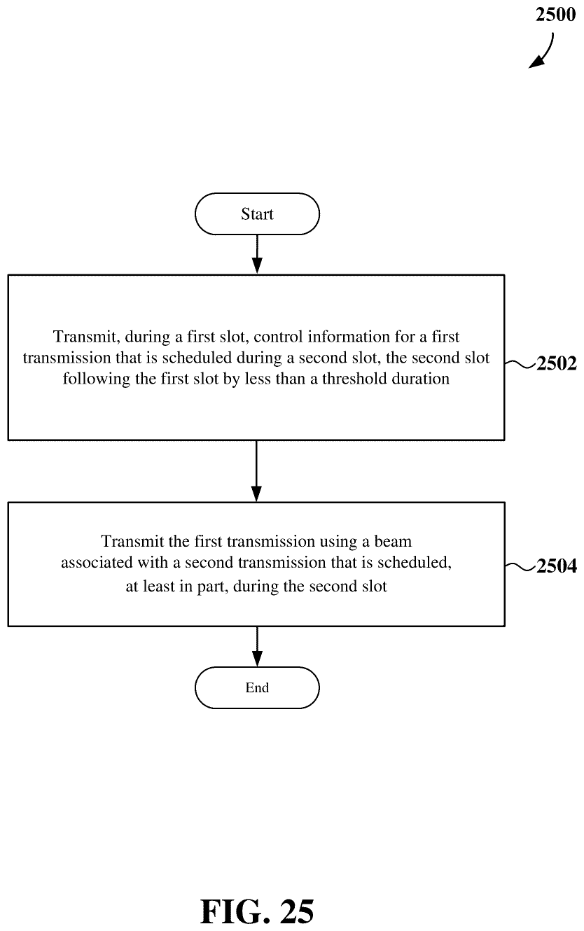

FIG. 25 is a flow chart illustrating an example method 2500 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 2500 may be carried out by the network entity 2200 illustrated in FIG. 22. In some examples, the method 2500 may be carried out by any suitable apparatus or means for carrying out the functions or algorithm described below.

At block 2502, a network entity may transmit, during a first slot, control information that schedules a first transmission during a second slot, the second slot following the first slot by a duration of time that is less than a threshold duration. In some examples, the transmit processing circuitry 2243 in cooperation with the communication and processing circuitry 2241 and the transceiver 2210, shown and described in FIG. 22, may provide a means to transmit, during a first slot, control information that schedules a first transmission during a second slot.

At block 2504, the network entity may transmit the first transmission using a beam associated with a second transmission that is scheduled, at least in part, during the second slot. In some examples, the transmit processing circuitry 2243 in cooperation with the communication and processing circuitry 2241 and the transceiver 2210, shown and described in FIG. 22, may provide a means to transmit the first transmission using a beam associated with a second transmission.

In one configuration, the network entity 2200 includes means for transmitting an indication of a first transmission configuration indicator state associated with a plurality of transmissions, means for transmitting, during a first slot, control information that schedules a first transmission during a second slot, the second slot following the first slot by a duration of time that is less than a threshold duration, and means for transmitting the first transmission using a beam indicated by the first transmission configuration indicator state. In one configuration, the network entity 2200 includes means for transmitting, during a first slot, control information that schedules a first transmission during a second slot, the second slot following the first slot by a duration of time that is less than a threshold duration, and means for transmitting the first transmission using a beam associated with a first control resource set of at least one control resource set being monitored by a user equipment. In one configuration, the network entity 2200 includes means for transmitting, during a first slot, control information that schedules a first transmission during a second slot, the second slot following the first slot by a duration of time that is less than a threshold duration, and means for transmitting the first transmission using a beam associated with a second transmission that is scheduled, at least in part, during the second slot. In one aspect, the aforementioned means may be the processor 2204 shown in FIG. 22 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 2204 is merely provided as an example, and other means for carrying out the described functions may be included within various aspects of the present disclosure, including but not limited to the instructions stored in the computer-readable medium 2206, or any other suitable apparatus or means described in any one or more of FIGS. 1, 2, 3, 8, 9, 11, and 22, and utilizing, for example, the methods and/or algorithms described herein in relation to FIGS. 23-25.

The methods shown in FIGS. 19-21 and 23-25 may include additional aspects, such as any single aspect or any combination of aspects described below and/or in connection with one or more other processes described elsewhere herein. The following provides an overview of several aspects of the present disclosure.

Aspect 1: A method for wireless communication at a user equipment, the method comprising: receiving an indication of a first transmission configuration indicator state associated with a plurality of transmissions; receiving, during a first slot, control information that schedules a first transmission during a second slot, the second slot following the first slot by a duration of time that is less than a threshold duration; and receiving the first transmission using a beam indicated by the first transmission configuration indicator state, the receiving the first transmission using the beam indicated by the first transmission configuration indicator state being based on the second slot following the first slot by the duration of time that is less than the threshold duration.

Aspect 2: The method of aspect 1, wherein the first transmission comprises a physical downlink shared channel transmission.

Aspect 3: The method of aspect 2, wherein the threshold duration specifies a minimum decoding time for the physical downlink shared channel transmission.

Aspect 4: The method of any of aspects 2 through 3, further comprising: identifying quasi co-location parameters for receiving the physical downlink shared channel transmission based on the first transmission configuration indicator state.

Aspect 5: The method of aspect 1, wherein the first transmission comprises an aperiodic channel state information reference signal transmission.

Aspect 6: The method of aspect 5, wherein the threshold duration specifies a minimum decoding time for the aperiodic channel state information reference signal transmission.

Aspect 7: The method of any of aspects 5 through 6, further comprising: identifying quasi co-location parameters for receiving the aperiodic channel state information reference signal transmission based on the first transmission configuration indicator state.

Aspect 8: The method of any of aspects 5 through 7, further comprising: receiving the first transmission using the beam indicated by the first transmission configuration indicator state based on the aperiodic channel state information reference signal transmission being configured to use the first transmission configuration indicator state.

Aspect 9: The method of any of aspects 5 through 7, further comprising: receiving the first transmission using the beam indicated by the first transmission configuration indicator state irrespective of whether the aperiodic channel state information reference signal transmission is configured to use the first transmission configuration indicator state.

Aspect 10: The method of any of aspects 5 through 7, further comprising: receiving the first transmission using the beam indicated by the first transmission configuration indicator state based on an absence of a second transmission scheduled, at least in part, during the second slot, and configured to use a transmission configuration indicator state.

Aspect 11: The method of any of aspects 1 through 10, further comprising: receiving a radio resource control configuration specifying that the user equipment is to receive transmissions using beams indicated by at least one transmission configuration indicator state if the user equipment has been configured with the at least one transmission configuration indicator state.

Aspect 12: The method of any of aspects 1 through 10, wherein the user equipment is configured with a rule specifying that the user equipment is to receive transmissions using beams indicated by at least one transmission configuration indicator state if the user equipment has been configured with the at least one transmission configuration indicator state.

Aspect 13: The method of any of aspects 1 through 12, further comprising: receiving the indication of the first transmission configuration indicator state via the control information.

Aspect 14: The method of any of aspects 1 through 12, further comprising: receiving the indication of the first transmission configuration indicator state via a medium access control-control element.

Aspect 16: A method for wireless communication at a user equipment, the method comprising: receiving, during a first slot, control information for a first transmission that is scheduled during a second slot, the second slot following the first slot by less than a threshold duration; and receiving the first transmission using a beam associated with a first control resource set of at least one control resource set being monitored by the user equipment, the first control resource set having a lowest control resource set identifier of the at least one control resource set, the receiving the first transmission using the beam associated with the first control resource set being based on an absence of, for the user equipment, a configured transmission configuration indicator state associated with a plurality of transmissions.

Aspect 17: The method of aspect 16, wherein: the at least one control resource set is associated with a first search space of an active bandwidth part of a serving cell for the user equipment that is being monitored by the user equipment; and the at least one control resource set is associated with a third slot that precedes the second slot and is closer to the second slot than any other slot associated with the first search space.

Aspect 18: The method of any of aspects 16 through 17, wherein the beam is indicated by a transmission configuration indicator for the first control resource set.

Aspect 19: The method of any of aspects 16 through 18, wherein the first transmission comprises a physical downlink shared channel transmission.

Aspect 20: The method of aspect 19, wherein the threshold duration specifies a minimum decoding time for the physical downlink shared channel transmission.

Aspect 21: The method of any of aspects 16 through 18, wherein the first transmission comprises an aperiodic channel state information reference signal transmission.

Aspect 22: The method of aspect 21, wherein the threshold duration specifies a minimum decoding time for the aperiodic channel state information reference signal transmission.

Aspect 23: The method of any of aspects 21 through 22, further comprising: receiving the first transmission using the beam associated with the first control resource set based on an absence of a second transmission scheduled, at least in part, during the second slot, and configured to use a transmission configuration indicator state.

Aspect 24: The method of any of aspects 16 through 23, further comprising: receiving a radio resource control configuration specifying that the user equipment is to receive transmissions using beams indicated by lowest control resource set identifiers if the user equipment has not been configured with at least one transmission configuration indicator state.

Aspect 25: The method of any of aspects 16 through 23, wherein the user equipment is configured with a rule specifying that the user equipment is to receive transmissions using beams indicated by lowest control resource set identifiers if the user equipment has not been configured with at least one transmission configuration indicator state.

Aspect 27: A method for wireless communication at a user equipment, the method comprising: receiving, during a first slot, control information for a first transmission that is scheduled during a second slot, the second slot following the first slot by less than a threshold duration; and receiving the first transmission using a beam associated with a second transmission that is scheduled, at least in part, during the second slot, the second transmission being configured to use a first transmission configuration indicator state that is associated with a plurality of transmissions.

Aspect 28: The method of aspect 27, wherein the first transmission comprises an aperiodic channel state information reference signal transmission.

Aspect 29: The method of aspect 28, wherein the threshold duration specifies a minimum decoding time for the aperiodic channel state information reference signal transmission.

Aspect 30: The method of any of aspects 28 through 29, further comprising: identifying quasi co-location parameters for receiving the aperiodic channel state information reference signal transmission based on the first transmission configuration indicator state.

Aspect 31: The method of any of aspects 27 through 30, further comprising: receiving the first transmission using the beam associated with the second transmission based on an absence of a configured transmission configuration indicator state for the user equipment.

Aspect 32: The method of any of aspects 27 through 31, further comprising: receiving a radio resource control configuration specifying that the user equipment is to receive transmissions using beams associated with other transmissions if the user equipment has not been configured with at least one transmission configuration indicator state.

Aspect 33: The method of any of aspects 27 through 31, wherein the user equipment is configured with a rule specifying that the user equipment is to receive transmissions using beams associated with other transmissions if the user equipment has not been configured with at least one transmission configuration indicator state.

Aspect 34: A user equipment comprising: a transceiver configured to communicate with a radio access network, a memory, and a processor coupled to the transceiver and the memory, wherein the processor and the memory are configured to perform any of aspects 1 through 15.

Aspect 35: An apparatus configured for wireless communication comprising at least one means for performing any one or more of aspects 1 through 15.

Aspect 36: A non-transitory computer-readable medium storing computer-executable code, comprising code for causing an apparatus to perform any of aspects 1 through 15.

Aspect 37: A user equipment comprising: a transceiver, a memory, and a processor coupled to the transceiver and the memory, wherein the processor and the memory are configured to perform any of aspects 16 through 25.

Aspect 38: An apparatus configured for wireless communication comprising at least one means for performing any of aspects 16 through 25.

Aspect 39: A non-transitory computer-readable medium storing computer-executable code, comprising code for causing an apparatus to perform any of aspects 16 through 25.

Aspect 40: A user equipment comprising: a transceiver, a memory, and a processor coupled to the transceiver and the memory, wherein the processor and the memory are configured to perform any of aspects 27 through 33.

Aspect 41: An apparatus configured for wireless communication comprising at least one means for performing any of aspects 27 through 33.

Aspect 42: A non-transitory computer-readable medium storing computer-executable code, comprising code for causing an apparatus to perform any of aspects 27 through 33.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-25 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 3, 8, 9, 11, 18, and 22 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment, comprising:
a transceiver;
a memory; and
a processor coupled to the memory and the transceiver, wherein the processor and the memory are configured to:
receive, via the transceiver, an indication of a first transmission configuration indicator state associated with a plurality of transmissions;
receive, via the transceiver during a first slot, control information that schedules a first transmission during a second slot, the second slot following the first slot by a duration of time that is less than a threshold duration; and
receive, via the transceiver, the first transmission using a beam indicated by the first transmission configuration indicator state, the reception of the first transmission using the beam indicated by the first transmission configuration indicator state being based on the second slot following the first slot by the duration of time that is less than the threshold duration.

2. The user equipment of claim 1, wherein the first transmission comprises a physical downlink shared channel transmission.

3. The user equipment of claim 2, wherein the threshold duration specifies a minimum decoding time for the physical downlink shared channel transmission.

4. The user equipment of claim 2, wherein the processor and the memory are further configured to:
identify quasi co-location parameters for receiving the physical downlink shared channel transmission based on the first transmission configuration indicator state.

5. The user equipment of claim 1, wherein the first transmission comprises an aperiodic channel state information reference signal transmission.

6. The user equipment of claim 5, wherein the threshold duration specifies a minimum decoding time for the aperiodic channel state information reference signal transmission.

7. The user equipment of claim 5, wherein the processor and the memory are further configured to:
identify quasi co-location parameters for receiving the aperiodic channel state information reference signal transmission based on the first transmission configuration indicator state.

8. The user equipment of claim 5, wherein the processor and the memory are further configured to:
receive the first transmission using the beam indicated by the first transmission configuration indicator state based on the aperiodic channel state information reference signal transmission being configured to use the first transmission configuration indicator state.

9. The user equipment of claim 5, wherein the processor and the memory are further configured to:
receive the first transmission using the beam indicated by the first transmission configuration indicator state irrespective of whether the aperiodic channel state information reference signal transmission is configured to use the first transmission configuration indicator state.

10. The user equipment of claim 5, wherein the processor and the memory are further configured to:
receive the first transmission using the beam indicated by the first transmission configuration indicator state based on an absence of a second transmission scheduled, at least in part, during the second slot, and configured to use a transmission configuration indicator state.

11. The user equipment of claim 1, wherein the processor and the memory are further configured to:
receive a radio resource control configuration specifying that the user equipment is to receive transmissions using beams indicated by at least one transmission configuration indicator state if the user equipment has been configured with the at least one transmission configuration indicator state.

12. The user equipment of claim 1, wherein the processor and the memory are further configured with a rule specifying that the user equipment is to receive transmissions using beams indicated by at least one transmission configuration indicator state if the user equipment has been configured with the at least one transmission configuration indicator state.

13. The user equipment of claim 1, wherein the processor and the memory are further configured to:
receive the indication of the first transmission configuration indicator state via the control information.

14. The user equipment of claim 1, wherein the processor and the memory are further configured to:
receive the indication of the first transmission configuration indicator state via a medium access control-control element.

15. A method for wireless communication at a user equipment, comprising:
receiving an indication of a first transmission configuration indicator state associated with a plurality of transmissions;
receiving, during a first slot, control information that schedules a first transmission during a second slot, the second slot following the first slot by a duration of time that is less than a threshold duration; and
receiving the first transmission using a beam indicated by the first transmission configuration indicator state, the receiving the first transmission using the beam indicated by the first transmission configuration indicator state being based on the second slot following the first slot by the duration of time that is less than the threshold duration.

16. A user equipment, comprising:
a transceiver;
a memory; and
a processor coupled to the memory and the transceiver, wherein the processor and the memory are configured to:
receive, via the transceiver during a first slot, control information for a first transmission that is scheduled during a second slot, the second slot following the first slot by less than a threshold duration; and
receive, via the transceiver, the first transmission using a beam associated with a first control resource set of at least one control resource set being monitored by the user equipment, the first control resource set having a lowest control resource set identifier of the at least one control resource set, the reception of the first transmission using the beam associated with the first control resource set being based on an absence of, for the user equipment, a configured transmission configuration indicator state associated with a plurality of transmissions.

17. The user equipment of claim 16, wherein:
the at least one control resource set is associated with a first search space of an active bandwidth part of a serving cell for the user equipment that is being monitored by the user equipment; and
the at least one control resource set is associated with a third slot that precedes the second slot and is closer to the second slot than any other slot associated with the first search space.

18. The user equipment of claim 16, wherein the beam is indicated by a transmission configuration indicator for the first control resource set.

19. The user equipment of claim 16, wherein the first transmission comprises a physical downlink shared channel transmission.

20. The user equipment of claim 19, wherein the threshold duration specifies a minimum decoding time for the physical downlink shared channel transmission.

21. The user equipment of claim 16, wherein the first transmission comprises an aperiodic channel state information reference signal transmission.

22. The user equipment of claim 21, wherein the threshold duration specifies a minimum decoding time for the aperiodic channel state information reference signal transmission.

23. The user equipment of claim 21, wherein the processor and the memory are further configured to:
receive the first transmission using the beam associated with the first control resource set based on an absence of a second transmission scheduled, at least in part, during the second slot, and configured to use a transmission configuration indicator state.

24. The user equipment of claim 16, wherein the processor and the memory are further configured to:
receive a radio resource control configuration specifying that the user equipment is to receive transmissions using beams indicated by lowest control resource set identifiers if the user equipment has not been configured with at least one transmission configuration indicator state.

25. The user equipment of claim 16, wherein the processor and the memory are further configured with a rule specifying that the user equipment is to receive transmissions using beams indicated by lowest control resource set identifiers if the user equipment has not been configured with at least one transmission configuration indicator state.

26. A method for wireless communication at a user equipment, comprising:
receiving, during a first slot, control information for a first transmission that is scheduled during a second slot, the second slot following the first slot by less than a threshold duration; and
receiving the first transmission using a beam associated with a first control resource set of at least one control resource set being monitored by the user equipment, the first control resource set having a lowest control resource set identifier of the at least one control resource set, the receiving the first transmission using the beam associated with the first control resource set being based on an absence of, for the user equipment, a configured transmission configuration indicator state associated with a plurality of transmissions.

27. A user equipment, comprising:
a transceiver;
a memory; and
a processor coupled to the memory and the transceiver, wherein the processor and the memory are configured to:
receive, via the transceiver during a first slot, control information for a first transmission that is scheduled during a second slot, the second slot following the first slot by less than a threshold duration; and
receive, via the transceiver, the first transmission using a beam associated with a second transmission that is scheduled, at least in part, during the second slot, the second transmission being configured to use a first transmission configuration indicator state that is associated with a plurality of transmissions.

28. The user equipment of claim 27, wherein the first transmission comprises an aperiodic channel state information reference signal transmission.

29. The user equipment of claim 28, wherein the threshold duration specifies a minimum decoding time for the aperiodic channel state information reference signal transmission.

30. The user equipment of claim 28, wherein the processor and the memory are further configured to:
identify quasi co-location parameters for receiving the aperiodic channel state information reference signal transmission based on the first transmission configuration indicator state.

31. The user equipment of claim 27, wherein the processor and the memory are further configured to:
receive the first transmission using the beam associated with the second transmission based on an absence of a configured transmission configuration indicator state for the user equipment.

32. The user equipment of claim 27, wherein the processor and the memory are further configured to:
receive a radio resource control configuration specifying that the user equipment is to receive transmissions using beams associated with other transmissions if the user equipment has not been configured with at least one transmission configuration indicator state.

33. The user equipment of claim 27, wherein the processor and the memory are further configured with a rule specifying that the user equipment is to receive transmissions using beams associated with other transmissions if the user equipment has not been configured with at least one transmission configuration indicator state.

34. A method for wireless communication at a user equipment, comprising:
receiving, during a first slot, control information for a first transmission that is scheduled during a second slot, the second slot following the first slot by less than a threshold duration; and
receiving the first transmission using a beam associated with a second transmission that is scheduled, at least in part, during the second slot, the second transmission being configured to use a first transmission configuration indicator state that is associated with a plurality of transmissions.
